(19) United States
(12) Patent Application Publication
(10) Pub. No.: US 2011/0254663 A1
(43) Pub. Date: Oct. 20, 2011

(54) WORK INFORMATION PROCESSOR, PROGRAM, AND WORK INFORMATION PROCESSING METHOD

(76) Inventors: Yushi Sakamoto, Tokyo (JP); Hideaki Suzuki, Yokohama (JP); Tomotoshi Ishida, Hitachinaka (JP); Shinichi Taniguchi, Yokohama (JP); Masahiro Watanabe, Hitachi (JP)

(21) Appl. No.: 13/125,125

(22) PCT Filed: Jun. 12, 2009
(86) PCT No.: PCT/JP2009/060796

§ 371 Date: Jul. 6, 2011

(30) Foreign Application Priority Data
Oct. 20, 2008 (JP) 2008-270006
Oct. 29, 2008 (JP) 2008-278249

(51) Int. Cl. G08B 5/22

(52) U.S. Cl. 340/8.1

(57) ABSTRACT

Although techniques for determining the positions of workers and products and displaying their tracks on a two-dimensional layout were available in the past, they were inconvenient in that work times and process shifts over time could not be grasped. A technique for grasping work contents of a worker highly accurately utilizing electronic tags was also available. However, it was also inconvenient in that the workers had to read the electronic tags intentionally while at work. The work information processor (100) is capable of showing passage of time and process shifts by specifying steps at given points in time by a position sensor (161) attached to a worker. Also represented is a work information processor that stores work content definition information for specifying work contents based on the information detected by the sensor and displays work contents along the passage of time, specifies work contents based on values detected by multiple sensors and the times of said detections according to work content definition information, and specifies work contents according to pieces of work content definition information.

### TECHNICAL FIELD

The present invention relates to a technology for processing work information.

### BACKGROUND ART

Up to now, there is a technology for measuring a position of a worker or a product and displaying a locus thereof on a two-dimensional layout (Patent Literature 1). Further, there is a technology for figuring out a worker's work content by a radio frequency identification (RFID) tag or the like (Patent Literature 2).

### CITATION LIST

### Patent Literature

PTL 1: JP 2002-73749 A
PTL 2: JP 2008-59116 A

### SUMMARY OF INVENTION

### Technical Problem

As a first problem, the technology disclosed in the above-mentioned Patent Literature 1 is inconvenient in that a change of a process step with respect to a change in time instant or a time taken for a work cannot be figured out from information displayed on a two-dimensional layout.

Further, as a second problem, the technology disclosed in the above-mentioned Patent Literature 2 is inconvenient in that a worker must consciously work on reading an RFID tag while at work even though a work content can be figured out with high accuracy.

Therefore, as a countermeasure against the above-mentioned first problem, the present invention has an object to provide a technology that can indicate the change of the process step with respect to the change in time instant.

Further, as a countermeasure against the above-mentioned second problem, the present invention has an object to provide a technology that allows the worker's work content to be identified and presented with high accuracy without forcing an extra operation on the worker.

### Solution to Problem

In order to solve the above-mentioned first problem, with a technology that processes work information according to the present invention, process steps on a time-by-time basis are identified from detection values obtained on a time-by-time basis from a sensor attached to a worker or the like by using stored process step information, and a relationship between the time instant and the process step is displayed.

For example, a work information processing apparatus comprises: a storage unit which stores process-step definition information including a position and a process step associated with the position; and a control unit, wherein the control unit is configured to: receive a detection value that indicates a position detected by a sensor attached to a sensing target and information that determines a time instant at which the detection value is detected, as detected information; determine the process step associated with the position indicated by the detection value from the process-step definition information; and display a change of the process step in which the sensing target exists, according to the detected time instants in coordinates having at least the process step as an axis thereof.

Further, in order to solve the above-mentioned second problem, work contents on a time-by-time basis are identified by using information that determines a work from detection values obtained on a time-by-time basis from the sensor attached to the worker or the like, and a relationship between the time instant and the work content is displayed.

For example, a work information processing apparatus comprises: a storage unit which stores work content definition information obtained by associating information determining a detection value sensed by a sensor with a work content; and a control unit, wherein the control unit is configured to: receive a detection value detected by a sensor attached to a first sensing target, information that determines a time instant at which the detection value of the first sensing target is detected, a detection value detected by a sensor attached to a second sensing target, and information that determines a time instant at which the detection value of the second sensing target is detected; determine the work content based on the detection value detected by the sensor attached to the first sensing target and the detection value detected by the sensor attached to the second sensing target according to the work content definition information; and display the determined work content according to information that determines the detected time instant.

### Advantageous Effects of Invention

It is possible to provide a technology that presents the change of the process step with respect to the change in time instant. Further, it is possible to provide a technology that allows the worker's work content to be identified and presented with high accuracy without forcing an extra operation on the worker.

### BRIEF DESCRIPTION OF DRAWINGS

FIG. 1 A schematic diagram of a work information processing system according to a first embodiment.

FIG. 2 A schematic diagram illustrating a sensed information processing apparatus according to the first embodiment.

FIG. 3 A diagram illustrating a data structure of a sensed information table according to the first embodiment.

FIG. 4 A diagram illustrating a layout of a workplace according to the first embodiment.

FIG. 5 A diagram illustrating a data structure of a process-step definition table according to the first embodiment.

FIG. 6 Diagrams illustrating a layout of regions of the workplace and a data structure of a region table according to the first embodiment.

FIG. 7 A diagram illustrating a data structure of an output information table according to the first embodiment.

FIG. 8 A diagram illustrating a hardware configuration of the sensed information processing apparatus.

FIG. 9 A diagram illustrating a processing flow of a situation display processing according to the first embodiment.

FIG. 10 A diagram illustrating an example of an output screen of the situation display processing according to the first embodiment.

FIG. 11 A diagram illustrating a data structure of an output information table according to a second embodiment.

FIG. 12 A diagram illustrating a processing flow of a situation display processing according to the second embodiment.

FIG. 13 A diagram illustrating an example of an output screen of the situation display processing according to the second embodiment.

FIG. 14 A diagram illustrating a data structure of a sensed information table according to a third embodiment.

FIG. 15 A diagram illustrating a data structure of an output information table according to the third embodiment.

FIG. 16 A diagram illustrating a processing flow of a situation display processing according to the third embodiment.

FIG. 17 A diagram illustrating an example of an output screen of the situation display processing according to the third embodiment.

FIG. 18A schematic diagram illustrating a sensed information processing apparatus according to a fourth embodiment.

FIG. 19 Diagrams illustrating a layout of detailed regions and a data structure of a detailed region table according to the fourth embodiment.

FIG. 20 A diagram illustrating a data structure of an output information table according to the fourth embodiment.

FIG. 21 A diagram illustrating a processing flow of a situation display processing according to the fourth embodiment.

FIG. 22 A diagram illustrating an example of a detailed display screen of the situation display processing according to the fourth embodiment.

FIG. 23A schematic diagram illustrating a work information processing system according to a fifth embodiment.

FIG. 24A schematic diagram illustrating a sensed information processing apparatus according to the fifth embodiment.

FIG. 25 A diagram illustrating a data structure of a worker sensed information table according to the fifth embodiment.

FIG. 26 A diagram illustrating a data structure of an apparatus sensed information table according to the fifth embodiment.

FIG. 27 A diagram illustrating a data structure of a product sensed information table according to the fifth embodiment.

FIG. 28 A diagram illustrating a data structure of an environment sensed information table according to the fifth embodiment.

FIG. 29 A diagram illustrating a data structure of a worker information table according to the fifth embodiment.

FIG. 30 A diagram illustrating a data structure of a work load information table according to the fifth embodiment.

FIG. 31 A diagram illustrating a data structure of a sensor mounting table according to the fifth embodiment.

FIG. 32 A diagram illustrating a data structure of a scheduled work information table according to the fifth embodiment.

FIG. 33 A diagram illustrating a data structure of a basic information table according to the fifth embodiment.

FIG. 34 A diagram illustrating a structure of a work definition file according to the fifth embodiment.

FIG. 35 A diagram illustrating a data structure of an output information table according to the fifth embodiment.

FIG. 36 A diagram illustrating a hardware configuration of the sensed information processing apparatus according to the fifth embodiment.

FIG. 37 A diagram illustrating a processing flow of a preliminary setting processing according to the fifth embodiment.

FIG. 38 A diagram illustrating a processing flow of a situation display processing according to the fifth embodiment.

FIG. 39 Diagrams illustrating a principle that determines a posture according to the fifth embodiment.

FIG. 40 A diagram illustrating an example of an output screen of the situation display processing according to the fifth embodiment.

FIG. 41 A diagram illustrating an example of another output screen of the situation display processing according to the fifth embodiment.

### DESCRIPTION OF EMBODIMENTS

Hereinafter, embodiments from a first embodiment to a fifth embodiment are described.

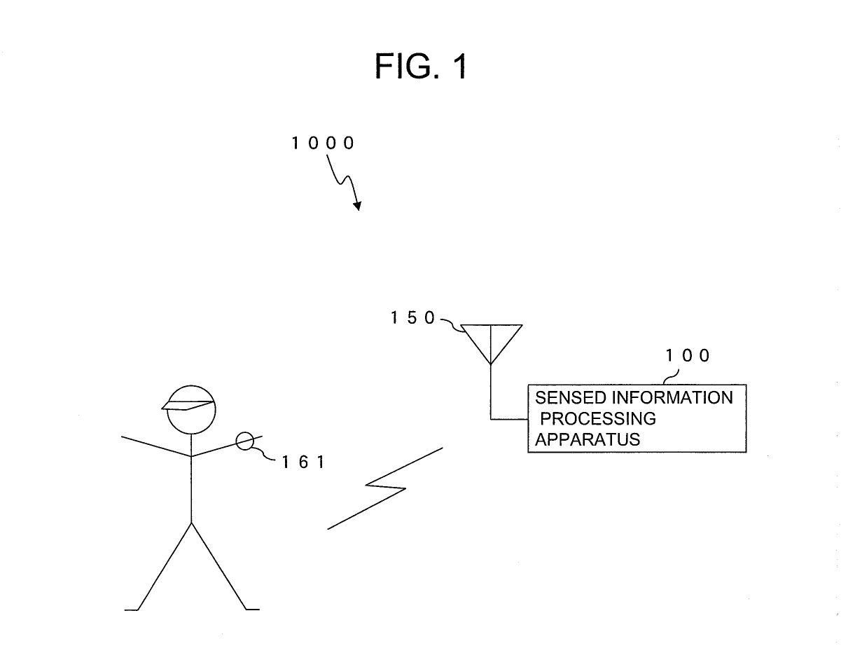

FIG. 1 is a diagram illustrating a work information processing system 1000 according to an embodiment of the present invention. The work information processing system 1000 includes a sensor 161 and a sensed information processing apparatus 100.

The sensor 161 is a sensor which detects a position of a person to which the sensor 161 is attached. In this embodiment, the sensor 161 is a position sensor which measures the position of the person within a work region on a plane (two dimensions of an X-coordinate and a Y-coordinate). For example, the sensor 161 is a sensor which acquires information on a latitude/longitude, such as a global positioning system (GPS).

It should be noted that the sensor 161 is not limited to the position sensor and may be of any kind as long as the sensor 161 can detect the position of a worker or the like. For example, the position of the person to which the sensor 161 is attached may be detected by using a plurality of antennas to receive a radio wave transmitted by a radio wave transmitter attached to a target worker and detecting the position from a radio field intensity.

Further, the sensor 161 transmits a detection value to the sensed information processing apparatus 100 via radio.

It should be noted that in FIG. 1, the sensor 161 is attached to the worker's left hand, but the present invention is not limited to such a mode, and any mode can be employed as long as the position of the worker or a work target item (product) can be detected.

The sensed information processing apparatus 100 receives the detection value transmitted from the sensor 161 by an antenna 150.

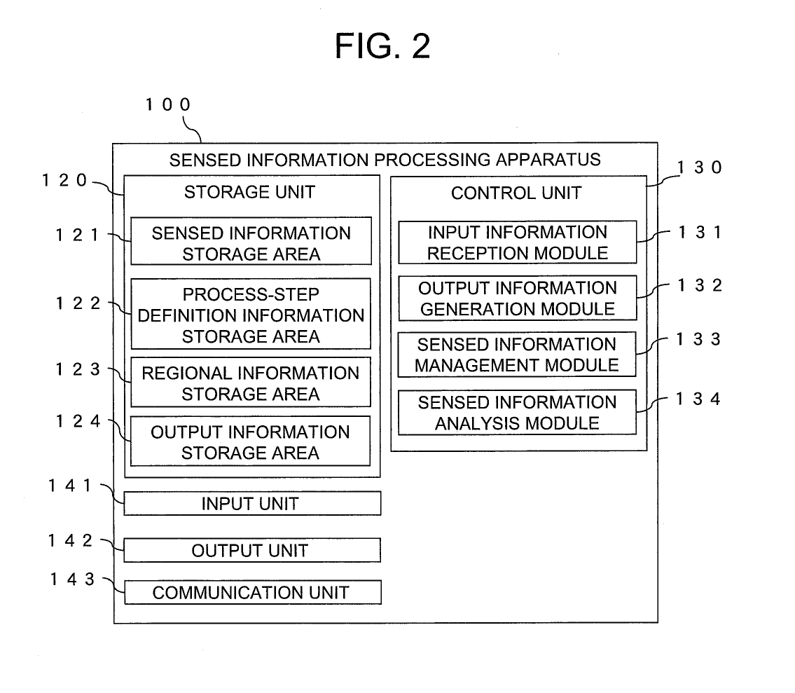

FIG. 2 is a schematic diagram of the sensed information processing apparatus 100.

As illustrated in the figure, the sensed information processing apparatus 100 includes a storage unit 120, a control unit 130, an input unit 141, an output unit 142, and a communication unit 143.

The storage unit 120 includes a sensed information storage area 121, a process-step definition information storage area 122, a regional information storage area 123, and an output information storage area 124.

Stored in the sensed information storage area 121 is a sensed information table 200 for storing sensed information.

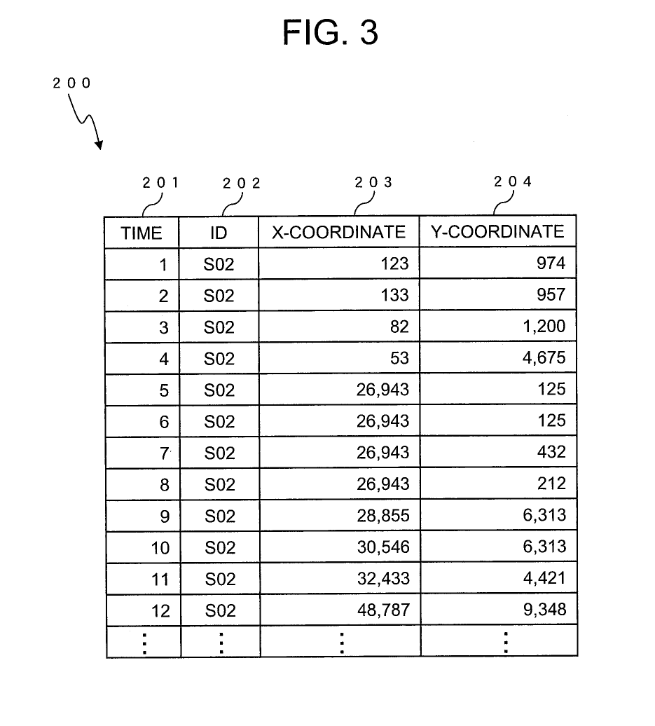

FIG. 3 illustrates a structure example of the sensed information table 200.

The sensed information table 200 includes a time field 201, an ID field 202, an X-coordinate field 203, and a Y-coordinate field 204.

The time field 201 stores information that determines a time instant at which the detection value detected by the sensor 161 is detected. In this embodiment, information that determines a time instant at which the detection value detected by the sensor 161 is received is stored.

It should be noted that by setting the detection value to be periodically transmitted from the sensor 161 and managing a specific time instant so as to correspond to the value stored in the time field 201 in the sensed information processing apparatus 100, it is possible to determine the time instant of each record. For example, “1”, “2”, “3”, . . . , and “n” correspond to the detection values “after 1 second”, “after 2 seconds”, . . . , and “after n seconds” from the start of recording, respectively.

The ID field 202 stores information that determines an ID being identification information for identifying the worker or a work target product to which the sensor 161 is attached.

In this embodiment, one ID is assigned to the sensor 161 attached to one worker or one product.

The X-coordinate field 203 stores a value regarding the X-coordinate of the detection value detected by the sensor 161 determined by the ID field 202.

The Y-coordinate field 204 stores a value regarding the Y-coordinate of the detection value detected by the sensor 161 determined by the ID field 202.

It should be noted that by attaching a sensor ID being identification information uniquely assigned to each sensor to the detection value transmitted from the sensor 161, the sensed information processing apparatus 100 can manage the ID corresponding to the sensor ID and store the detection value detected by the sensor 161 in the corresponding X-coordinate field 203 and Y-coordinate field 204.

Stored in the process-step definition information storage area 122 is a process-step definition table 300 for storing information that defines a process step.

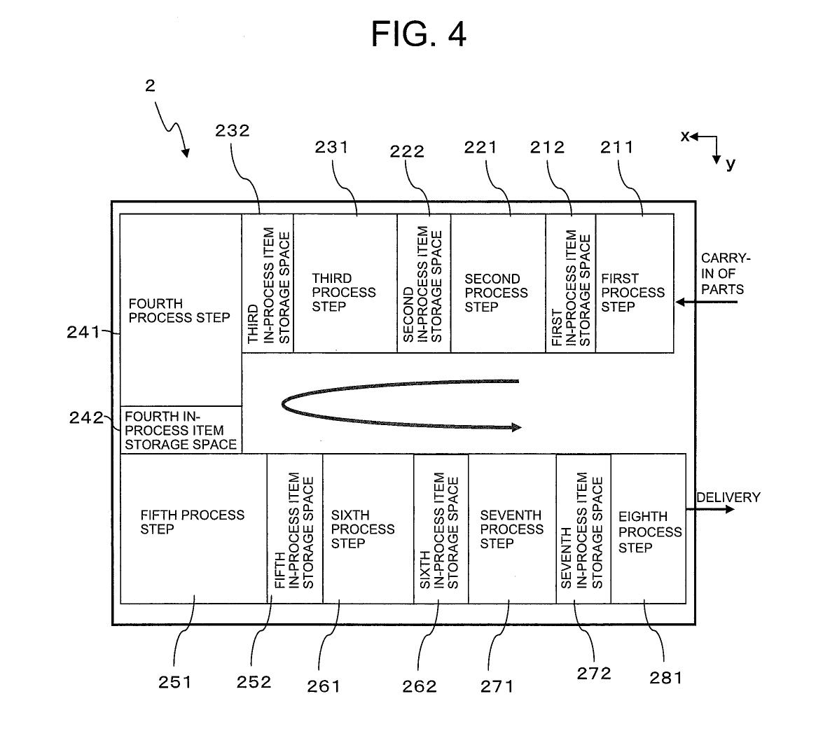

As a precondition for describing the process-step definition table 300, FIG. 4 is referenced to describe a physical arrangement of a workplace 2.

FIG. 4 is a diagram illustrating a two-dimensional layout of the workplace 2.

The workplace 2 includes a parts carry-in entrance and a product delivery exit, which are provided to one wall surface, and a first process-step work region 211, a first in-process item storage space 212, a second process-step work region 221, a second in-process item storage space 222, a third process-step work region 231, a third in-process item storage space 232, a fourth process-step work region 241, a fourth in-process item storage space 242, a fifth process-step work region 251, a fifth in-process item storage space 252, a sixth process-step work region 261, a sixth in-process item storage space 262, a seventh process-step work region 271, a seventh in-process item storage space 272, and an eighth process-step work region 281, which are provided to a floor surface.

Parts of the product carried in from the parts carry-in entrance of the workplace 2 become work targets of a first process step in the first process-step work region 211. When the work of the first process step is finished, the parts are accumulated in the first process-step in-process item storage space, and when a second process step is started, the parts are passed over to the second process-step work region to become work targets of the second process step.

In the above-mentioned manner, over the process steps from the first process step to an eighth process step, the parts are assembled to a product to be shipped from the product delivery exit.

Further, as illustrated in FIG. 4, the position on the workplace 2 can be expressed by a coordinate system having two axes, that is, an X-axis and a Y-axis orthogonal to the X-axis, with a predetermined position as an origin point.

In this embodiment, the X-axis is set to have a direction extending from the first process-step work region 211 to the third process-step in-process item storage space 231 along the wall surface in the long-side direction of the workplace 2, and the Y-axis is set to have a direction extending from the fourth process-step work region 241 to the fifth process-step work region 251 along the wall surface in the short-side direction of the workplace 2, with their origin at the position of a corner of the workplace 2 to which the parts carry-in entrance is provided.

The respective work regions from the first process-step work region 211 to the third in-process item storage space 232 are arranged toward the positive direction of the X-axis along the wall surface in one long-side direction of the workplace 2, the respective work regions from the fourth process-step work region to the fourth in-process item storage space 242 are arranged toward the positive direction of the Y-axis along the wall surface in the short-side direction of the workplace 2 which is opposed to the wall surface provided with the parts carry-in entrance, and the respective work regions from the fifth process-step work region 251 to the eighth process-step work region 281 are arranged toward the negative direction of the X-axis along the wall surface in the other long-side direction of the workplace 2.

In the above-mentioned manner, the parts carried in from the parts carry-in entrance are assembled as the product along a U-shaped flow line via the respective process steps, and carried out from a product carry-out exit.

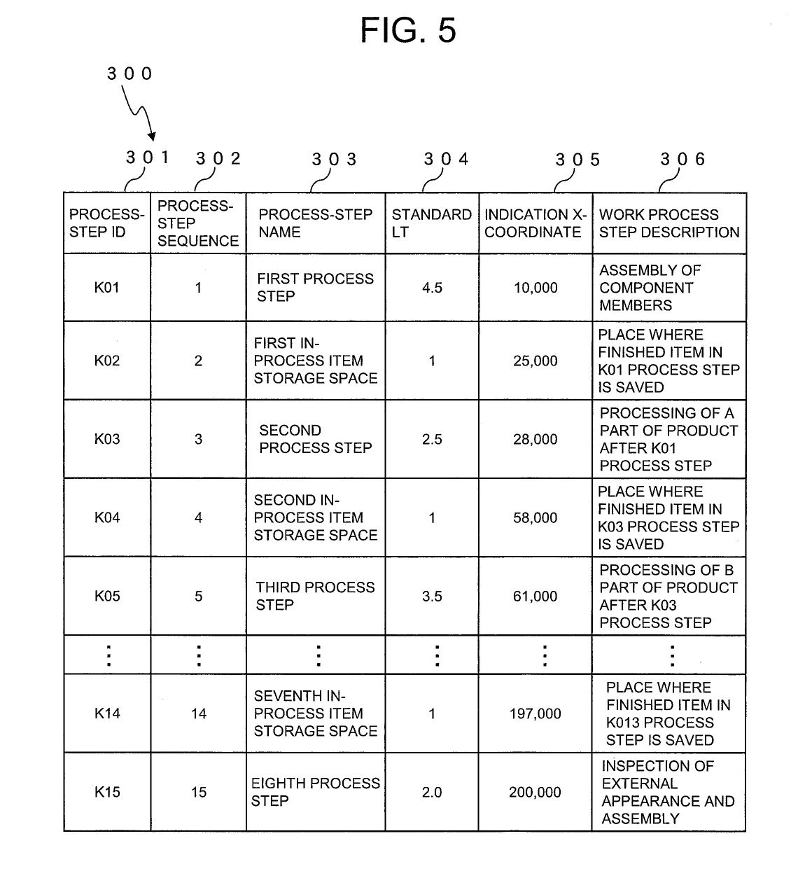

FIG. 5 illustrates a structure example of the process-step definition table 300.

The process-step definition table 300 includes a process-step ID field 301, a process-step sequence field 302, a process-step name field 303, a standard lead time (LT) field 304, an indication X-coordinate field 305, and a work process step description field 306.

The process-step ID field 301 stores a process-step ID being information that identifies the process step.

The process-step sequence field 302 stores information that determines a sequence for carrying out the process step. Examples thereof include continuous numerical values without an overlap such as “1”, “2”, . . . , and “n (n is a natural number equal to or larger than 1)”, and the sequence of the process step being “1” indicates that the process step is carried out in the first place.

The process-step name field 303 stores an alias that identifies the process step.

The standard LT field 304 stores a standard required time required to carry out the process step.

The indication X-coordinate field 305 stores information regarding a coordinate used to indicate the position or the like of the product or the worker on a display screen such as a display screen 550 described later.

It should be noted that the coordinate stored in the indication X-coordinate field 305 is such a value as to become larger as the product advances along the process steps sequentially.

Stored in the work process step description field 306 is information indicating contents of each of the process steps.

Stored in the regional information storage area 123 is a region table 450 for determining a physical region corresponding to the process step.

It should be noted that as a precondition, in this embodiment, the process step refers to a unit serving as a measure of management of the work. Further, the place/region in which the process step is carried out and the process step have a fixed correlation therebetween. Therefore, in principle, in the workplace 2, the same process step is not carried out in different places, and one process step that is carried out is always determined by the position of the worker or the product of the work target.

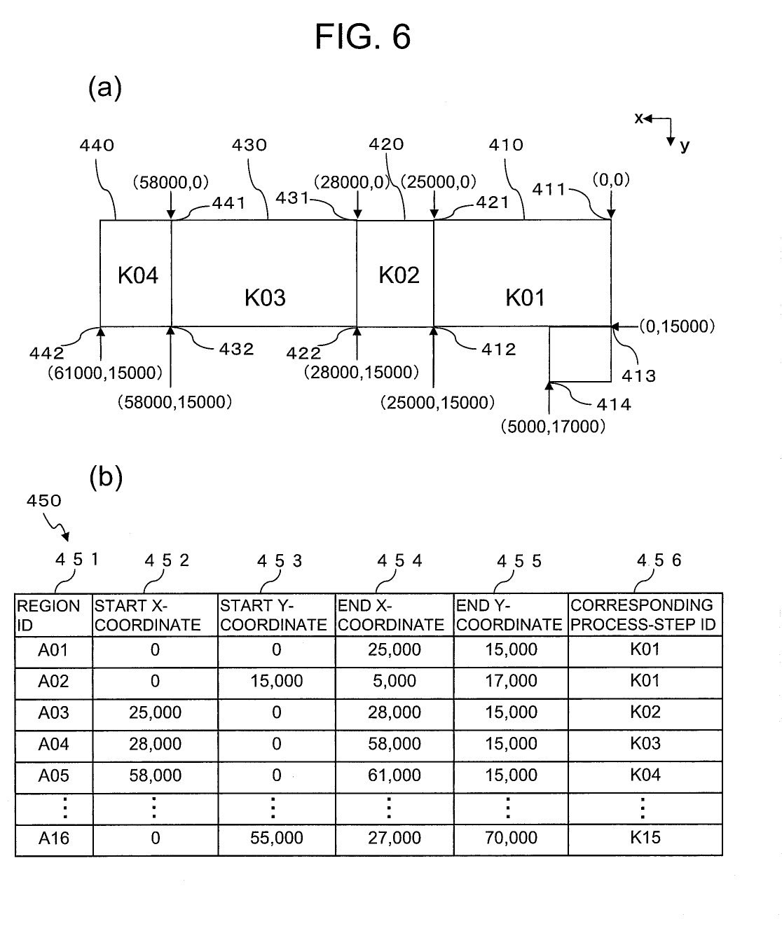

FIG. 6(a) is a diagram illustrating in detail the partial arrangement of the first process-step work region 211, the first in-process item storage space 212, the second process-step work region 221, and the second in-process item storage space 222 of the workplace 2 illustrated in FIG. 4.

A K01 region 410, a K02 region 420, a K03 region 430, and a K04 region 440 of FIG. 6(a) correspond to the first process-step work region 211, the first in-process item storage space 212, the second process-step work region 221, and the second in-process item storage space 222, respectively, of the workplace 2 illustrated in FIG. 4.

The K01 region includes a first region and a second region.

The first region is a region surrounded by a point 411 expressed by the X-coordinate being 0 and the Y-coordinate being 0 (hereinafter, referred to as “(0,0)”), a point 412 expressed by (25000,15000), a point 413 expressed by (0,15000), and a point 421 expressed by (25000,0).

The second region is a region surrounded by the point 413 expressed by (0,15000), a point expressed by (0,17000), a point 414 expressed by (5000,17000), and a point expressed by (5000,15000).

The K02 region is a region surrounded by the point 421 expressed by (25000,0), a point 422 expressed by (28000,15000), the point 412 expressed by (25000,15000), and a point 431 expressed by (28000,0).

The K03 region is a region surrounded by the point 431 expressed by (28000,0), a point 432 expressed by (58000,15000), the point 422 expressed by (28000,15000), and a point 441 expressed by (58000,0).

The K04 region is a region surrounded by the point 441 expressed by (58000,0), a point 442 expressed by (61000,15000), the point 432 expressed by (58000,15000), and a point expressed by (61000,0).

Based on such an arrangement as illustrated in FIG. 6A, FIG. 6B illustrates the region table 450 that stores information that defines an area of each of the regions by coordinates of two vertices connected by a diagonal line of each of the regions.

The region table 450 includes a region ID field 451, a start X-coordinate field 452, a start Y-coordinate field 453, an end X-coordinate field 454, an end Y-coordinate field 455, and a corresponding process-step ID field 456.

The region ID field 451 stores the region ID as information that identifies the region.

The start X-coordinate field 452 stores information regarding the X-coordinate of a first vertex being one vertex of two vertices that are opposed to each other across a diagonal line of the region.

The start Y-coordinate field 453 stores information regarding the Y-coordinate of the first vertex.

The end X-coordinate field 454 stores information regarding the X-coordinate of a second vertex opposed to the first vertex across the diagonal line.

The end Y-coordinate field 455 stores information regarding the Y-coordinate the second vertex.

The corresponding process-step ID field 456 stores the process-step ID of the process step carried out in the region determined by the value stored in the region ID field 451.

Stored in the output information storage area 124 is an output information table 500 for storing information to be output.

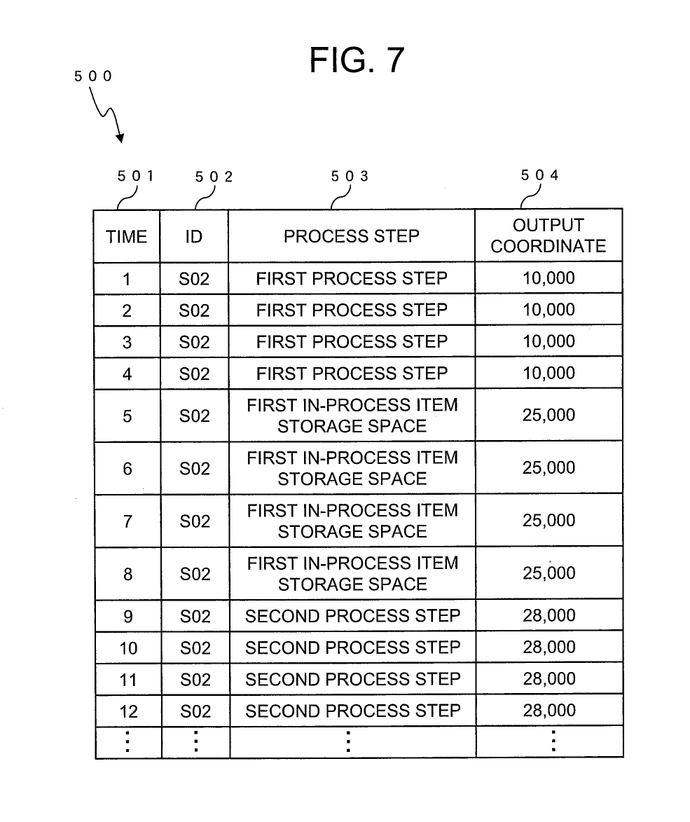

FIG. 7 illustrates a structure example of the output information table 500.

The output information table 500 includes a time field 501, an ID field 502, a process step field 503, and an output coordinate field 504.

The time field 501 stores information that determines a time instant at which the detection value detected by the sensor 161 is detected. In this embodiment, information that determines a time instant at which the detection value detected by the sensor 161 is received is stored.

The ID field 502 stores information that determines an ID being identification information for identifying the worker or the work target product to which the sensor 161 is attached.

The process step field 503 stores information that determines a process step determined based on the position of the worker or the work target product to which the sensor 161 is attached.

The output coordinate field 504 stores information that determines an output coordinate used when the position of the worker or the work target product to which the sensor 161 is attached is displayed on a screen.

FIG. 2 is referenced again for the description.

The control unit 130 includes an input information reception module 131, an output information generation module 132, a sensed information management module 133, and a sensed information analysis module 134.

The input information reception module 131 receives information input through the input unit 141 described later.

The output information generation module 132 forms an output screen by combining information to be output and a screen layout, and makes the output unit 142 described later to display the output screen.

The sensed information management module 133 performs a processing which stores the detection value received from each of the sensors 161 via the communication unit 143 described later in the sensed information table 200.

It should be noted that the sensed information management module 133 stores a correlation between the sensor ID of the sensor 161 and the ID for identifying the worker, and stores an ID corresponding to the sensor ID attached to a measured value received from the sensor 161 in the ID field 202 of the sensed information table 200.

Further, the sensed information management module 133 stores the time instant at which the measured value is received in a region (not shown) of the storage unit 120.

The sensed information analysis module 134 uses the information stored in the sensed information table 200 to determine which process step a target to which the sensor 161 is attached is in for each of the sensors 161.

Specifically, the sensed information analysis module 134 determines the X-coordinate and the Y-coordinate from the detection value detected from the sensor 161.

Then, from among records stored in the region table 450, the sensed information analysis module 134 determines the record in which the determined X-coordinate exists between the value of the start X-coordinate field 452 and the value of the end X-coordinate field 454 and in which the determined Y-coordinate exists between the value of the start Y-coordinate field 453 and the value of the end Y-coordinate field 455.

Then, the sensed information analysis module 134 determines the process-step ID stored in the corresponding process-step ID field 456 of the determined record.

Then, from among records stored in the process-step definition table 300, the sensed information analysis module 134 determines the values of the process-step name field 303 and the indication X-coordinate field 305 of the record having the determined process-step ID which matches the value of the process-step ID field 301 within the process-step definition table 300.

Then, the sensed information analysis module 134 stores information on the determined process step and information on the output coordinate in the process step field 503 and the output coordinate field 504, respectively, of the output information table 500.

The input unit 141 receives an input of information from an operator.

The output unit 142 outputs information.

The communication unit 143 performs transmission/reception of information through the antenna 150.

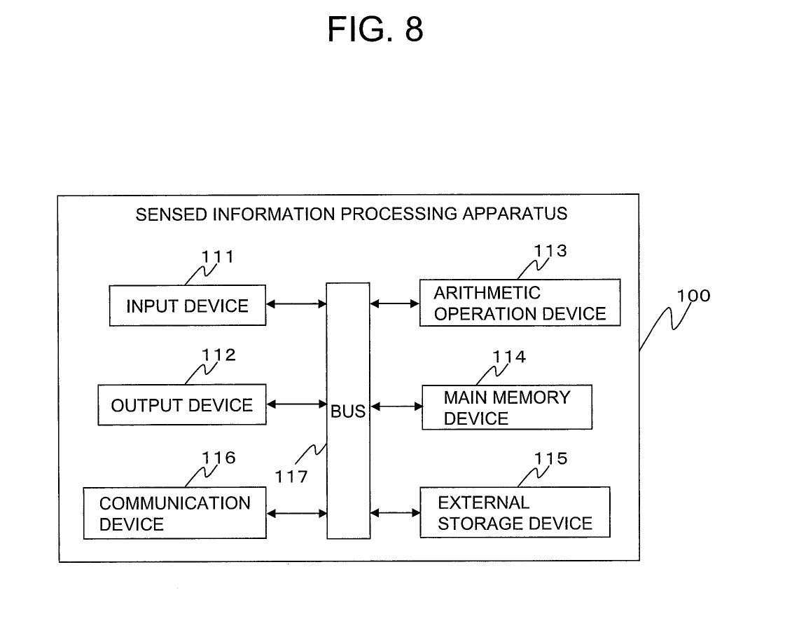

FIG. 8 is a diagram illustrating a hardware configuration of the sensed information processing apparatus 100 according to this embodiment.

In this embodiment, the sensed information processing apparatus 100 is a computer such as a client PC (personal computer), a workstation, a server device, each of various mobile phone terminals, or a personal digital assistant (PDA).

The sensed information processing apparatus 100 includes an input device 111, an output device 112, an arithmetic operation device 113, a main memory device 114, an external storage device 115, a communication device 116, and a bus 117 that connects the respective devices.

The input device 111 is a device which receives an input such as a keyboard, a mouse, a touch pen, or other such pointing devices.

The output device 112 is a device which performs displaying such as a display.

The arithmetic operation device 113 is an arithmetic operation device such as a central processing unit (CPU).

The main memory device 114 is a memory device such as a random access memory (RAM).

The external storage device 115 is a nonvolatile storage device such as a hard disk drive or a flash memory.

The communication device 116 is a communication device which performs radio communications through an antenna, such as a radio communication unit.

The input information reception module 131, the output information generation module 132, the sensed information management module 133, and the sensed information analysis module 134 of the sensed information processing apparatus 100 are implemented by programs that makes the arithmetic operation device 113 of the sensed information processing apparatus 100 to perform processings.

The above-mentioned programs, which are stored within the main memory device 114 or the external storage device 115, are loaded onto the main memory device 114 before execution thereof, and executed by the arithmetic operation device 113.

Further, the storage unit 120 of the sensed information processing apparatus 100 is implemented by the main memory device 114 or the external storage device 115 of the sensed information processing apparatus 100.

The input unit 141 of the sensed information processing apparatus 100 is implemented by the input device 111 of the sensed information processing apparatus 100.

The output unit 142 of the sensed information processing apparatus 100 is implemented by the output device 112 of the sensed information processing apparatus 100.

The communication unit 143 of the sensed information processing apparatus 100 is implemented by the communication device 116 of the sensed information processing apparatus 100.

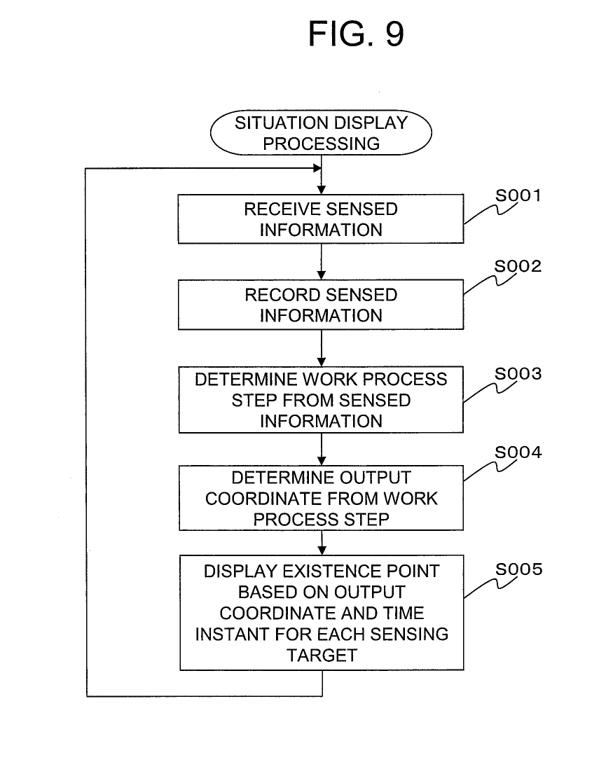

Next, FIG. 9 is referenced to describe a flow of a situation display processing according to this embodiment.

FIG. 9 is a flowchart illustrating the flow of the situation display processing.

First, the sensed information management module 133 receives the detection value transmitted from the sensor 161 via the communication unit 143 at predetermined intervals (for example, every one second) (Step S001).

Specifically, the sensed information management module 133 receives the detection value transmitted from the sensor 161 via the communication unit 143.

Subsequently, the sensed information management module 133 stores the detection value received in Step S001 in the sensed information table 200 (Step S002).

Subsequently, the sensed information analysis module 134 determines a work process step from sensed information (Step S003).

Specifically, the sensed information analysis module 134 reads the values of the X-coordinate field 203 and the Y-coordinate field 204 of the sensed information table 200.

Then, from among the records stored in the region table 450, the sensed information analysis module 134 determines a record in which the read X-coordinate exists between the value of the start X-coordinate field 452 and the value of the end X-coordinate field 454 and in which the read Y-coordinate exists between the value of the start Y-coordinate field 453 and the value of the end Y-coordinate field 455.

Then, the sensed information analysis module 134 determines the process-step ID stored in the corresponding process-step ID field 456 of the determined record.

Subsequently, the sensed information analysis module 134 determines the output coordinate from the process-step ID of the work process step determined in Step S003 (Step S004).

Specifically, from among the records stored in the process-step definition table 300, the sensed information analysis module 134 determines the values of the process-step name field 303 and the indication X-coordinate field 305 of a record having the process-step ID determined in Step S003 matches the value of the process-step ID field 301 within the process-step definition table 300.

Then, the sensed information analysis module 134 stores the information on the determined process step and the information on the determined output coordinate in the process step field 503 and the output coordinate field 504, respectively, of the output information table 500.

Subsequently, the output information generation module 132 uses the information within the output information table 500 to form and display a screen (Step S005).

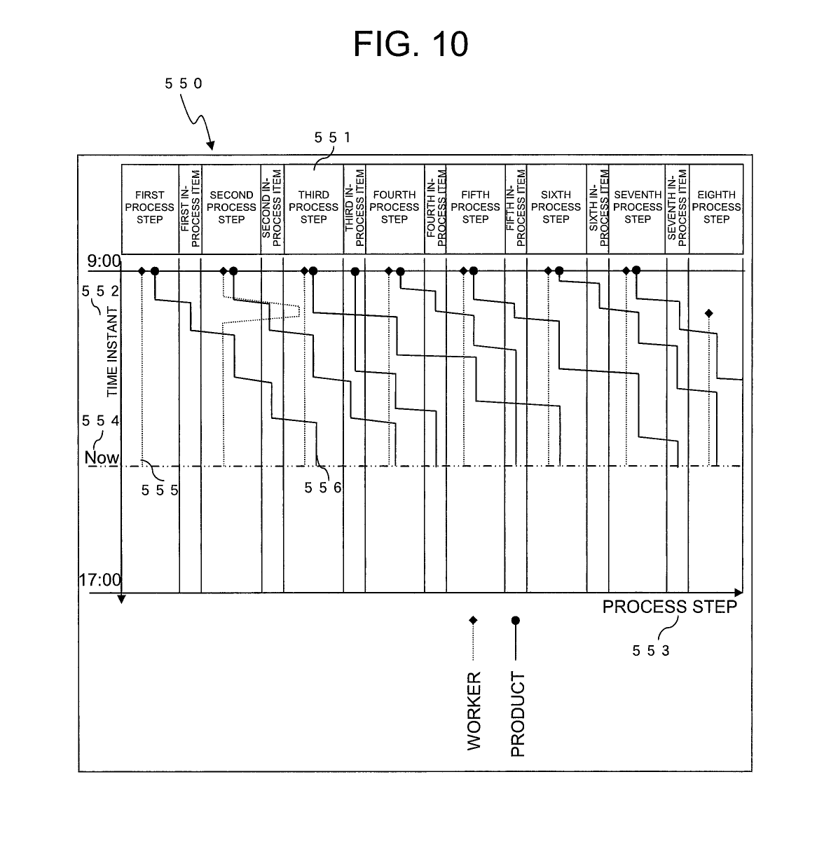

Specifically, with regard to the records of the output information table 500, the output information generation module 132 displays points in display positions determined by the output coordinate field 504 in ascending order of the values of the time field 501 for each value of the ID field 502, to thereby form and display the situation display screen 550 illustrated in FIG. 10.

In this case, when a sensing target moves to a different process step, the output information generation module 132 the sensing target by adding an oblique line connecting the previous point in the process step before the movement to the point after the movement.

FIG. 10 is a diagram illustrating an example of the situation display screen 550.

The situation display screen 550 includes a process-step display field 551, a time instant axis line 552, a process-step axis line 553, a present time instant indicating line 554, a worker position indicating line 555, and a product position indicating line 556.

The process-step display field 551 includes, along a process step order of the process-step axis line 553, a first process step field, a first in-process item field, a second process step field, a second in-process item field, a third process step field, a third in-process item field, a fourth process step field, a fourth in-process item field, a fifth process step field, a fifth in-process item field, a sixth process step field, a sixth in-process item field, a seventh process step field, a seventh in-process item field, and an eighth process step field.

The respective fields of the process-step display field 551 correspond to the first process-step work region 211, the first in-process item storage space 212, the second process-step work region 221, the second in-process item storage space 222, the third process-step work region 231, the third in-process item storage space 232, the fourth process-step work region 241, the fourth in-process item storage space 242, the fifth process-step work region 251, the fifth in-process item storage space 252, the sixth process-step work region 261, the sixth in-process item storage space 262, the seventh process-step work region 271, the seventh in-process item storage space 272, and the eighth process-step work region 281 of the workplace 2.

It should be noted that the value of the indication X-coordinate field 305 of the process-step definition table 300 and the value of the output coordinate field 504 of the output information table 500 are values that determine the coordinates around the center of the respective fields of the process-step display field 551. The output information generation module 132 displays the position of the product and the position of the worker on the display screen such as the display screen 550 at respectively different coordinates so as not to the positions being overlapped. For example, the output information generation module 132 adds/subtracts a predetermined value to/from the value of the output coordinate field 504 of the output information table 500, to thereby make the display position of the product and the display position of the worker to differ from each other.

Further, display breadths of the respective fields of the process-step display field 551 may be set according to the lengths of the process steps in terms of the layout. For example, the display breadths may be set wider in proportion to the lengths of the process steps in terms of the layout in a direction toward the subsequent process step.

Alternatively, the display breadths of the respective fields of the process-step display field 551 may be set to be proportionate to a standard lead time of the process step, or may be simply set as regular intervals.

The time instant axis line 552, which serves as a vertical axis directed downward from the top of the situation display screen 550, indicates a flow of the time instant.

The process-step axis line 553, which serves as a horizontal axis directed rightward from the left of the situation display screen 550, indicates a flow of the work process step.

The present time instant indicating line 554 indicates a time instant corresponding to the present time instant on the time instant axis line 552.

The worker position indicating line 555 is a line that connects points indicating the positions of the sensor 161 on a time-by-time basis attached to the worker.

The product position indicating line 556 is a line that connects points indicating the positions of the sensor 161 on a time-by-time basis attached to the product of the work target or the like.

In other words, for example, if the worker of the sensing target or the like exists in the first process-step work region 211, the situation display screen 550 displays the point in the position corresponding to the detected time instant at the center of the first process step field, and displays the points, which are recorded from the start of detection until the present time instant, as the worker position indicating line 555.

Then, the detected information management module 133 returns the processing to Step S001, and receives the sensed information.

The flow of the situation display processing has been described above.

According to the first embodiment of the present invention, the sensed information processing apparatus 100 can detect the positions of the worker and the product that are the sensing targets, determine the process step and the time instant, and use the situation display screen 550 to present the correspondence between the process step and a passage of time in the form of an at-a-glance chart.

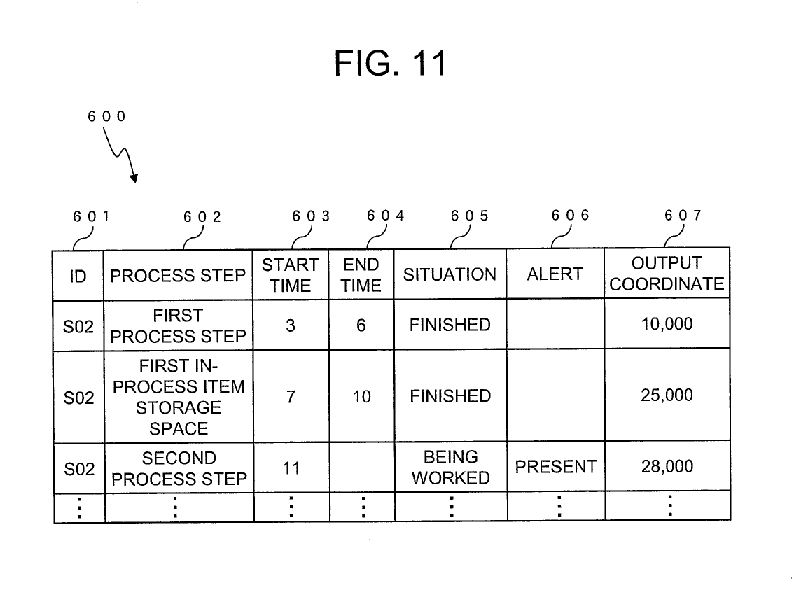

Next, FIGS. 11 to 13 are referenced to describe the second embodiment of the present invention.

A sensed information processing apparatus 100 according to the second embodiment of the present invention is, in principle, the same as the sensed information processing apparatus 100 according to the first embodiment, and hence the following description is directed to different points therebetween.

In the second embodiment, an output information table stored in the output information storage region 124 of the storage unit 120 is an output information table 600 illustrated in FIG. 11.

The output information table 600 includes an ID field 601, a process step field 602, a start time field 603, an end time field 604, a situation field 605, an alert field 606, and an output coordinate field 607.

The ID field 601 stores information that determines the ID being the identification information for identifying the work target product to which the sensor 161 is attached.

The process step field 602 stores information that determines the process step determined from the position of the work target product to which the sensor 161 is attached.

The start time field 603 stores information that indicates a time at which the process step within the process step field 602 is started with regard to the product identified by the ID stored in the ID field 601.

The end time field 604 stores information that indicates a time at which the process step within the process step field 602 is finished with regard to the product identified by the ID stored in the ID field 601.

The situation field 605 stores information that indicates a state of the process step within the process step field 602 with regard to the product identified by the ID stored in the ID field 601. Examples thereof include “finished” and “being worked”.

The alert field 606 stores information that indicates whether or not there occurs an event to be alerted after the process step within the process step field 602 is started, with regard to the product identified by the ID stored in the ID field 601. For example, “present” indicates that the event to be alerted has occurred.

The output coordinate field 607 stores information that determines the output coordinate used when the position of the work target product to which the sensor 161 is attached is displayed on the screen.

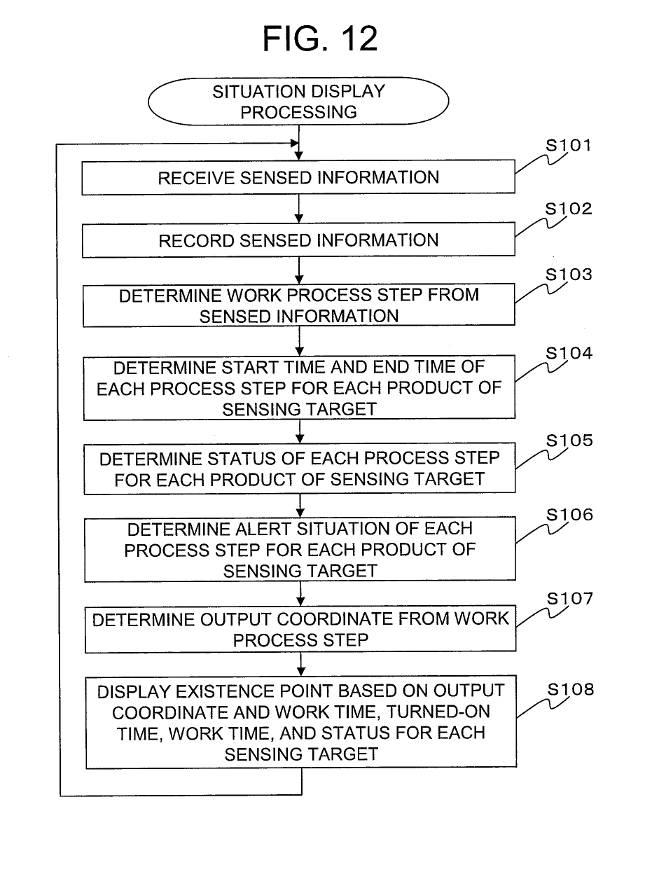

FIG. 12 illustrates a processing flow of a situation display processing according to the second embodiment.

First, the sensed information management module 133 receives the detection value transmitted from the sensor 161 via the communication unit 143 at predetermined intervals (for example, every one second) (Step S101).

Specifically, the sensed information management module 133 receives the detection value transmitted from the sensor 161 via the communication unit 143.

Subsequently, the sensed information management module 133 stores the detection value received in Step S101 in the sensed information table 200 (Step S102).

Subsequently, the sensed information analysis module 134 determines a work process step from sensed information (Step S103).

Specifically, the sensed information analysis module 134 reads the values of the X-coordinate field 203 and the Y-coordinate field 204 of the sensed information table 200.

Then, from among the records stored in the region table 450, the sensed information analysis module 134 determines a record in which the read X-coordinate exists between the value of the start X-coordinate field 452 and the value of the end X-coordinate field 454 and in which the read Y-coordinate exists between the value of the start Y-coordinate field 453 and the value of the end Y-coordinate field 455.

Then, the sensed information analysis module 134 determines the process-step ID stored in the corresponding process-step ID field 456 of the determined record.

Subsequently, the sensed information analysis module 134 determines the start time and the end time of the process step determined in Step S103 for each product of the sensing target (Step S104).

Specifically, the sensed information analysis module 134 determines a time at which switching of the process step is over for each ID of the product of the sensing target from the sensed information table 200.

Then, the sensed information analysis module 134 stores the values of the time field 201, immediately before and after the process step switching is over, in the end time field 604 and the start time field 603 of the output information table 600 as the end time of the process step before the switching and the start time of the process step after the switching, respectively.

Subsequently, the sensed information analysis module 134 determines a status of each of the process steps for each product of the sensing target (Step S105).

Specifically, with regard to the output information table 600, for each combination between the product of the sensing target and the process step determined in Step S103, if the start time field 603 and the end time field 604 each store a value, the sensed information analysis module 134 stores “finished” information indicating that the process step is finished in the situation field 605. The information called “being worked” indicating that the process step is not finished is stored in the situation field 605 if the start time field 603 stores a value but the end time field 604 does not store a value.

Subsequently, the sensed information analysis module 134 determines the alert situation of each of the process steps for each product of the sensing target (Step S106).

Specifically, with regard to the output information table 600, for each combination between the product of the sensing target and the process step determined in Step S103, the sensed information analysis module 134 judges whether or not the event to be alerted occurs between the value of the start time field 603 and the value of the end time field 604 (if the end time is not stored, a value indicating the present time instant), and if the event to be alerted occurs, the information called “present” is stored in the alert field 606.

It should be noted that examples of the event to be alerted include a case where a time taken to end the process step exceeds the standard LT field 304 of the process-step definition table 300 in the process step corresponding to the process step determined in Step S103.

Subsequently, the sensed information analysis module 134 determines the output coordinate from the process-step ID of the work process step determined in Step S103 (Step S107).

Specifically, from among the records of the process-step definition table 300, the sensed information analysis module 134 determines the values of the process-step name field 303 and the indication X-coordinate field 305 of a record having the process-step ID determined in Step S103 matches the value of the process-step ID field 301 of the process-step definition table 300.

Then, the sensed information analysis module 134 stores the information on the determined process step and the information on the output coordinate in the process step field 602 and the output coordinate field 607, respectively, of the output information table 600.

Subsequently, the output information generation module 132 uses the information within the output information table 600 to form and display the screen (Step S108).

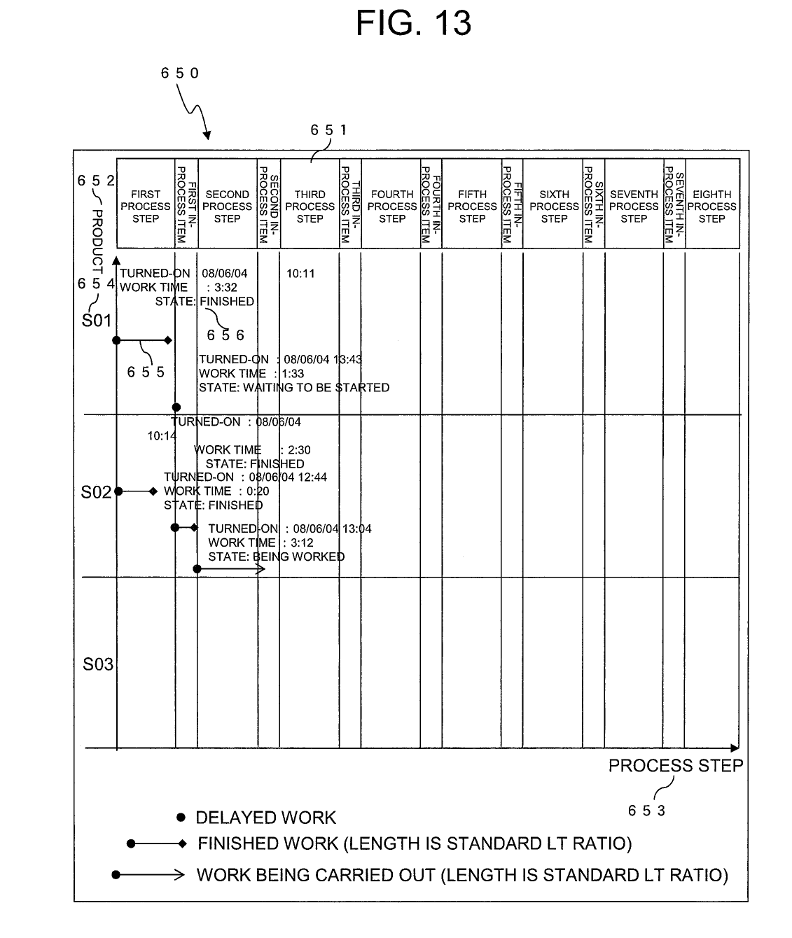

Specifically, with regard to the records of the output information table 600, for each of the values of the ID field 601, the output information generation module 132 displays a line segment in the display position of the corresponding process step according to a ratio of an elapsed time to the standard lead time of the process step, to thereby form and display a progress display screen 650 illustrated in FIG. 13.

FIG. 13 is a diagram illustrating an example of the progress display screen 650.

The progress display screen 650 includes a process-step display field 651, a product axis line 652, a process-step axis line 653, an ID display field 654, a work requiring time ratio indicating line 655, and a details indicating field 656.

The process-step display field 651 includes, along a process step order of the process-step axis line 653, a first process step field, a first in-process item field, a second process step field, a second in-process item field, a third process step field, a third in-process item field, a fourth process step field, a fourth in-process item field, a fifth process step field, a fifth in-process item field, a sixth process step field, a sixth in-process item field, a seventh process step field, a seventh in-process item field, and an eighth process step field.

The respective fields of the process-step display field 651 correspond to the first process-step work region 211, the first in-process item storage space 212, the second process-step work region 221, the second in-process item storage space 222, the third process-step work region 231, the third in-process item storage space 232, the fourth process-step work region 241, the fourth in-process item storage space 242, the fifth process-step work region 251, the fifth in-process item storage space 252, the sixth process-step work region 261, the sixth in-process item storage space 262, the seventh process-step work region 271, the seventh in-process item storage space 272, and the eighth process-step work region 281 of the workplace 2.

It should be noted that the value of the indication X-coordinate field 305 of the process-step definition table 300 and the value of the output coordinate field 607 of the output information table 600 are values that determine the coordinates around the left edge of the respective fields of the process-step display field 651.

Further, display breadths of the respective fields of the process-step display field 651 may be set according to the lengths of the process steps in terms of the layout. For example, the display breadths may be set wider in proportion to the lengths of the process steps in terms of the layout in a direction toward the subsequent process step.

Alternatively, the display breadths of the respective fields of the process-step display field 651 may be set to be proportionate to a standard lead time of the process step, or may be simply set as regular intervals.

The product axis line 652, which serves as a vertical axis directed upward from the bottom of the progress display screen 650, indicates a flow along which the IDs that identify the products are arrayed in order.

The process-step axis line 653, which serves as a horizontal axis directed rightward from the left of the progress display screen 650, indicates a flow of the work process step.

The ID display field 654 indicates an ID corresponding to the product on the product axis line 652.

The work requiring time ratio indicating line 655 indicates a line that makes the value of a ratio of the required time taken for each of the process steps of the sensor 161 attached to the product to the standard lead time to be displayed as a ratio of the length of the work requiring time ratio indicating line 655 to the width of each of the process step fields.

It should be noted that the work requiring time ratio indicating line 655 is displayed with the elapsed time until the present time being regarded as a work requiring time with regard to the work being performed.

The details indicating field 656 is a field that indicates details of information indicated by the work requiring time ratio indicating line 655 as textual information. For example, the details indicating field 656 is a field that indicates a time instant at which each of the process steps is turned on, a work time, and information on a work state or the like.

According to the progress display screen 650, for example, if the product of the sensing target exists in the first process-step work region 211 for 90 percent of the standard lead time, the situation display screen 650 displays the work requiring time ratio indicating line 655 having a length of 90 percent of the width of the first process step starting from the left edge of the first process step field, and displays the details indicating field 656 indicating a time/date at which the process step is started, the work time, and the fact of being in the finished state.

Then, the detected information management module 133 returns the processing to Step S101, and receives the sensed information.

The flow of the situation display processing in the second embodiment has been described above.

According to the second embodiment of the present invention, the sensed information processing apparatus 100 can detect the position of the product being the sensing target, determine the process step and the time instant, and display the time required to carry out the process step as a ratio thereof to the standard lead time.

With the above-mentioned configuration, the user of the sensed information processing apparatus 100 can review progress information on the work in the form of an at-a-glance chart.

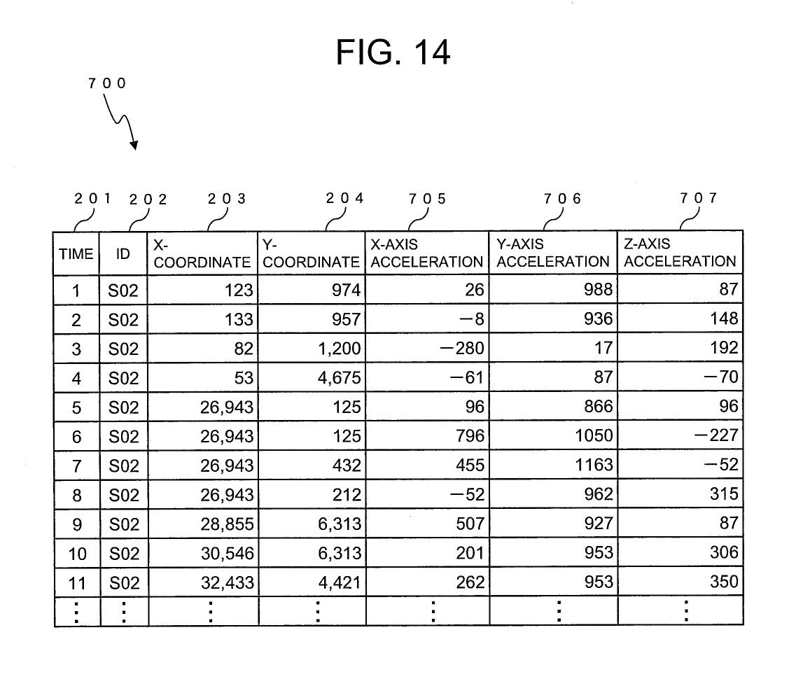

Next, FIGS. 14 to 17 are referenced to describe the third embodiment of the present invention.

The sensor 161 according to the third embodiment of the present invention has a function of, in addition to the position sensor, an acceleration sensor which detects an acceleration divided into acceleration components of three axes of an X-axis, a Y-axis, and a Z-axis that are orthogonal to one another.

It should be noted that the three axes of the X-axis, the Y-axis, and the Z-axis with which the sensor 161 detects the acceleration are independent axes irrelevant to the X-coordinate and the Y-coordinate that indicate the position detected by the sensor 161.

Further, a sensed information processing apparatus 100 according to the third embodiment of the present invention is, in principle, the same as the sensed information processing apparatus 100 according to the first embodiment, and hence the following description is directed to different points therebetween.

In the third embodiment, the sensed information table 200 stored in the sensed information storage area 121 of the storage unit 120 is a sensed information table 700 illustrated in FIG. 14.

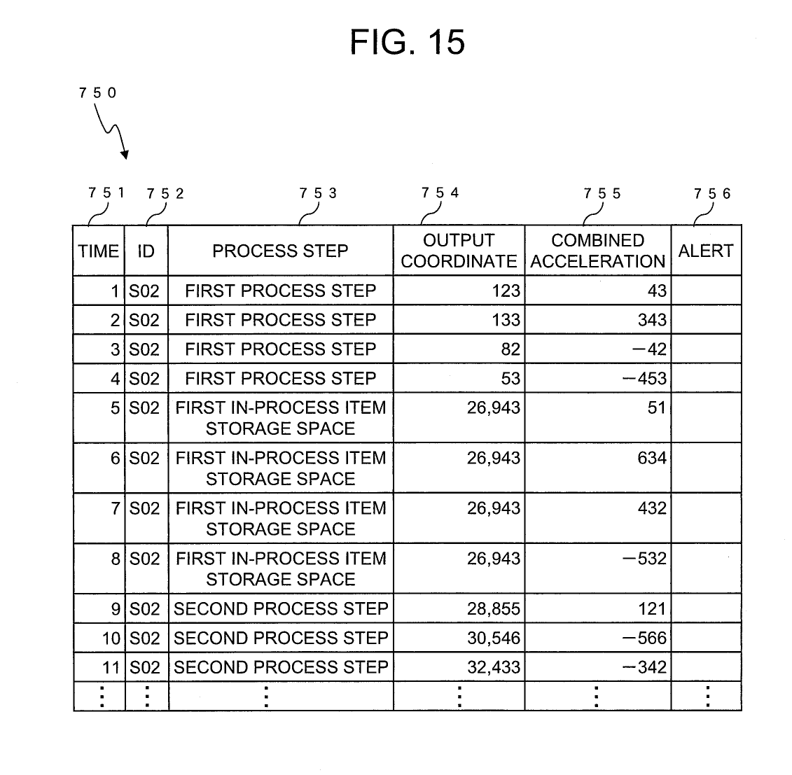

Further, an output information table stored in the output information storage area 124 is an output information table 750 illustrated in FIG. 15.

FIG. 14 illustrates a structure example of the sensed information table 700 according to the third embodiment.

The sensed information table 700 includes an X-axis acceleration field 705, a Y-axis acceleration field 706, and a Z-axis acceleration field 707 in addition to the respective fields included in the sensed information table 200 according to the first embodiment.

The X-axis acceleration field 705 stores the magnitude of an X-axis component among accelerations detected by the sensor 161 in units of milli-G ( 1/1000 G).

The Y-axis acceleration field 706 stores the magnitude of a Y-axis component among the accelerations detected by the sensor 161 in units of milli-G.

The Z-axis acceleration field 707 stores the magnitude of a Z-axis component among the accelerations detected by the sensor 161 in units of milli-G.

FIG. 15 illustrates a structure example of the output information table 750 according to the third embodiment.

The output information table 750 includes a time field 751, an ID field 752, a process step field 753, an output coordinate field 754, a combined acceleration field 755, and an alert field 756.

The time field 751 stores the information that determines the time instant at which the detection value detected by the sensor 161 is detected. In this embodiment, the information that determines a time instant at which the detection value detected by the sensor 161 is received is stored.

The ID field 752 stores the information that determines the ID being the identification information for identifying the worker to which the sensor 161 is attached.

The process step field 753 stores the information that determines the process step determined from the position of the worker to which the sensor 161 is attached.

The output coordinate field 754 stores the information that determines the output coordinate used when the position of the worker to which the sensor 161 is attached is displayed on the screen.

The combined acceleration field 755 stores the value of the magnitude of the acceleration obtained by combining the acceleration components of the three axes which have been measured by the sensor 161.

The alert field 756 stores the information that indicates whether or not there occurs an event to be alerted after the process step within the process step field 753 is started, with regard to the target identified by the ID stored in the ID field 752. For example, “present” indicates that the event to be alerted has occurred.

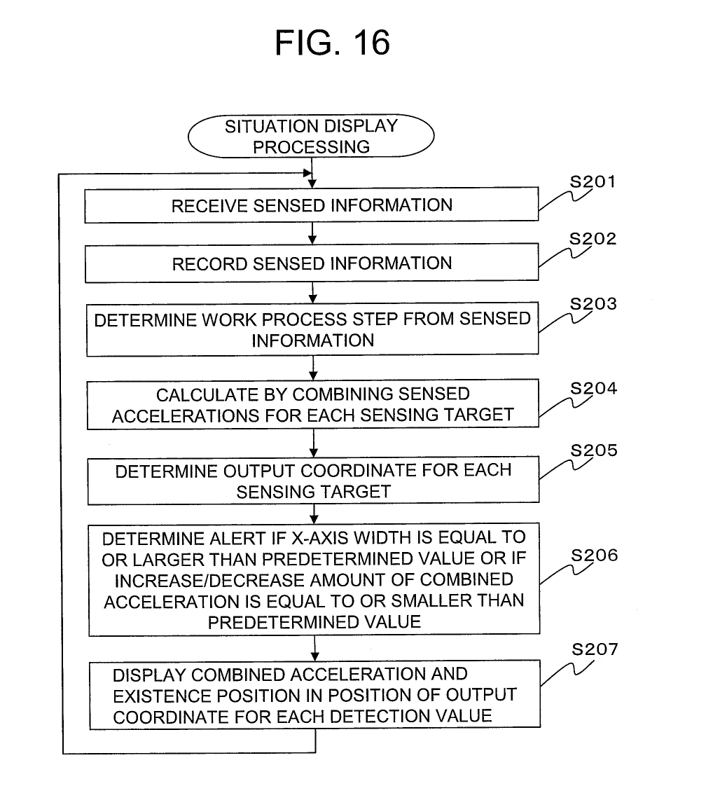

FIG. 16 illustrates a processing flow of a situation display processing in the third embodiment.

First, the sensed information management module 133 receives the detection value transmitted from the sensor 161 via the communication unit 143 at predetermined intervals (for example, every one second) (Step S201).

Specifically, the sensed information management module 133 receives the detection value transmitted from the sensor 161 via the communication unit 143.

Subsequently, the sensed information management module 133 stores the detection value received in Step S101 in the sensed information table 700 (Step S202).

Subsequently, the sensed information analysis module 134 determines a work process step from sensed information (Step S203).

Specifically, the sensed information analysis module 134 reads the values of the X-coordinate field 203 and the Y-coordinate field 204 of the sensed information table 700.

Then, from among the records stored in the region table 450, the sensed information analysis module 134 determines a record in which the read X-coordinate exists between the value of the start X-coordinate field 452 and the value of the end X-coordinate field 454 and in which the read Y-coordinate exists between the value of the start Y-coordinate field 453 and the value of the end Y-coordinate field 455.

Then, the sensed information analysis module 134 determines the process-step ID stored in the corresponding process-step ID field 456 of the determined record.

Subsequently, the sensed information analysis module 134 calculates the magnitude of the acceleration obtained by combining the sensed accelerations of the three axes for each worker of the sensing target (Step S204).

Specifically, the sensed information analysis module 134 calculates the acceleration obtained by combining the sensed accelerations of the three axes for each ID of the worker of the sensing target, and stores the acceleration in the combined acceleration field 755 of the output information table 750.

Subsequently, the sensed information analysis module 134 determines the output coordinate for each worker of the sensing target (Step S205).

Specifically, with regard to the output information table 750, for each combination between the production worker of the sensing target and the process step determined in Step S203, based on the values of the sensed X-coordinate and the sensed Y-coordinate, the sensed information analysis module 134 determines the coordinate on the screen to be displayed by indicating the position of the worker by a distance corresponding to a route from the parts carry-in entrance in the workplace 2, and stores the coordinate in the output coordinate field 754.

For example, if the process step corresponding to the detected position is the process step to be carried out earlier than that of the third in-process item storage space 232, the sensed information analysis module 134 stores the value of the sensed X-coordinate in the output coordinate field 754 as it is.

Alternatively, if the process step corresponding to the detected position is that of the fourth process-step work region 241 or the fourth in-process item storage space 242, the sensed information analysis module 134 stores a value obtained by adding the value of the sensed Y-coordinate to the value of the X-coordinate regarding any of the points on a line in which the third in-process item storage space 232 contacts with the fourth process-step work region 241, in the output coordinate field 754.

Alternatively, if the process step corresponding to the detected position is the process step to be carried out later than a fifth process step 251, the sensed information analysis module 134 stores a value obtained by adding the value of the sensed Y-coordinate to a value obtained by subtracting the value of the sensed X-coordinate from a value obtained by doubling the X-coordinate regarding any of the points on a line in which the fourth in-process item storage space 242 contacts with the fifth process-step work region 251, in the output coordinate field 754.

Subsequently, the sensed information analysis module 134 determines the alert situation for each worker of the sensing target (Step S206).

Specifically, with regard to the output information table 750, for each worker of the sensing target, the sensed information analysis module 134 stores the information called “present” in the alert field 756 by assuming that a useless movement is being performed or a necessary working action is not being performed if the width between the upper limit and the lower limit of the value of the output coordinate field 754 exceeds a predetermined threshold value or if an increase/decrease amount of the value of the combined acceleration field 755 within a predetermined period is equal to or smaller than a predetermined threshold value.

It should be noted that the event to be alerted is not limited to the above description as long as the alert is issued if the worker is not performing a predefined work.

Subsequently, the output information generation module 132 uses the information within the output information table 750 to form and display a screen (Step S207).

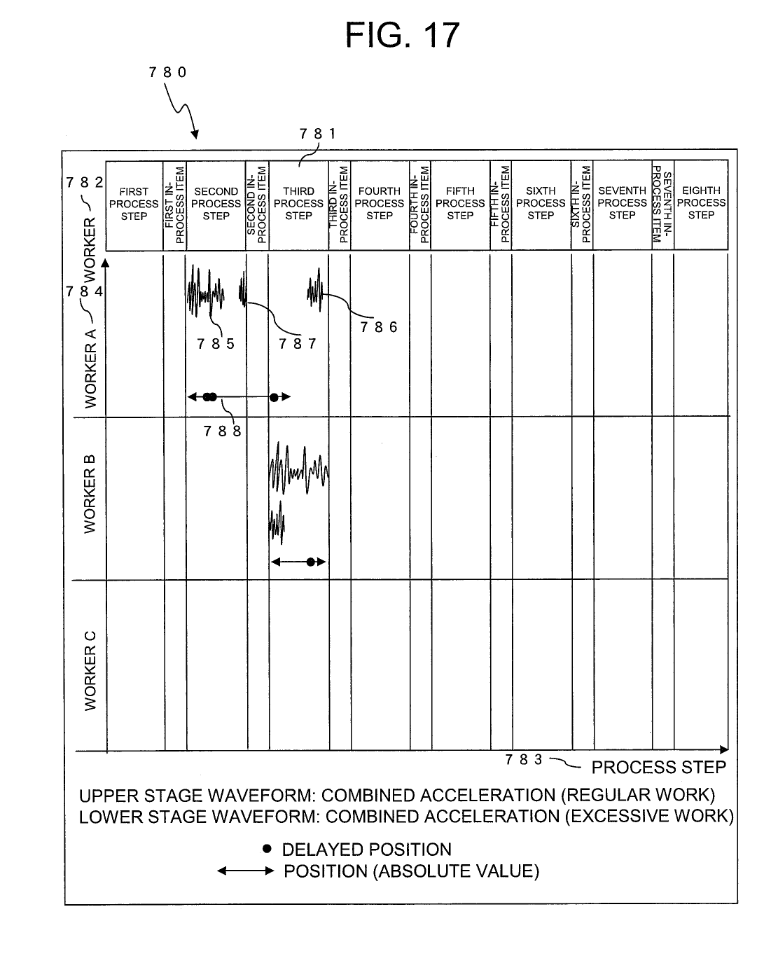

Specifically, with regard to the records of the output information table 750, for each of the values of the ID field 751, the output information generation module 132 displays a change over time of the combined acceleration in the position of the carried-out process step in the form of a graph. Further, the line segment is displayed in the position of the process step carried out by the worker, to thereby form and display an activity situation display screen 780 illustrated in FIG. 17.

FIG. 17 is a diagram illustrating an example of the activity situation display screen 780.

The activity situation display screen 780 includes a process-step display field 781, a worker axis line 782, a process-step axis line 783, a worker display field 784, an acceleration indicating line 785, and a movement area line 788 of the worker.

The process-step display field 781 is the same as the process step display field 651 according to the second embodiment, and hence description thereof is omitted. However, the display breadths of the respective fields of the process-step display field 781 is set wider in proportion to the lengths of the process steps in terms of the layout in a direction toward the subsequent process step.

The worker axis line 782, which serves as a vertical axis directed upward from the bottom of the activity situation display screen 780, indicates an axis along which the IDs or names that identify the workers are arrayed in order.

The process-step axis line 783, which serves as a horizontal axis directed rightward from the left of the activity situation display screen 780, indicates the flow of the work process step. It should be noted that the position within each of the process steps of the process-step display field 781, which corresponds to a predetermined position within each of the process steps in terms of the layout, is defined to have a proportional relationship between the length from the start point of the process step in terms of the layout up to the position in a direction toward the subsequent process step and the length up to the display position in terms of the display in a direction from the left edge of the field of each of the process steps of the process-step display field 781 toward the right edge thereof.

The worker display field 784 indicates a name of the worker corresponding to the worker on the worker axis line 782.

The acceleration indicating line 785 indicates a graph in which an increase amount of the magnitude of a combined acceleration for each of the times at which the detection is performed by the sensor 161 attached to the worker is recorded along a time axis (whose origin point is set in a predetermined position at the top of the left edge of the process step) provided to each process step in a direction parallel to the process-step axis line 783.

The increase amount of the magnitude of the acceleration, which is one of the axes of the acceleration indicating line 785, is provided in a direction parallel to the worker axis line 782.

It should be noted that if the worker performs a work in another process step, the acceleration indicating line 785 is fragmentarily displayed in a portion indicating the corresponding time instant of the process step performed while discontinuing the graph. Therefore, with regard to a worker A of FIG. 17, an acceleration indicating line 786 indicates the combined acceleration obtained when the work is performed in the third process-step work region, and an acceleration indicating line 787 is a fragment indicating the combined acceleration of the work performed thereafter in the second process-step work region.

The movement area line 788 of the worker indicates an area within which the worker has moved.

The area within which the worker has moved is represented by a line that couples points to one another, the points being displayed in the display positions within the respective process steps of the process-step display field 781, which correspond to the positions of the worker within the respective process steps in terms of the layout. For example, the activity situation display screen 780 of FIG. 17 indicates that the worker A has moved across the second process-step work region, the second in-process item storage space, and a part of the third process-step work region.

It should be noted that the acceleration indicating line of a worker B of FIG. 17 has vertically two stages, in which the upper stage indicates a regular-time work and the lower stage indicates an excessive work (so-called overtime work).

In the above-mentioned manner, according to the activity situation display screen 780, the movement area of the worker and the quantity of acceleration of the worker on a per-time basis can be presented at a glance.

Then, the detected information management module 133 returns the processing to Step S201, and receives the sensed information.

The flow of the situation display processing in the third embodiment has been described above.

According to the third embodiment of the present invention, the sensed information processing apparatus 100 can detect the position and the acceleration of the worker being the sensing target, determine the area of the process step that has been carried out and the change amount of an action on a time-by-time basis, and display the area and the change amount in the form of an at-a-glance chart.

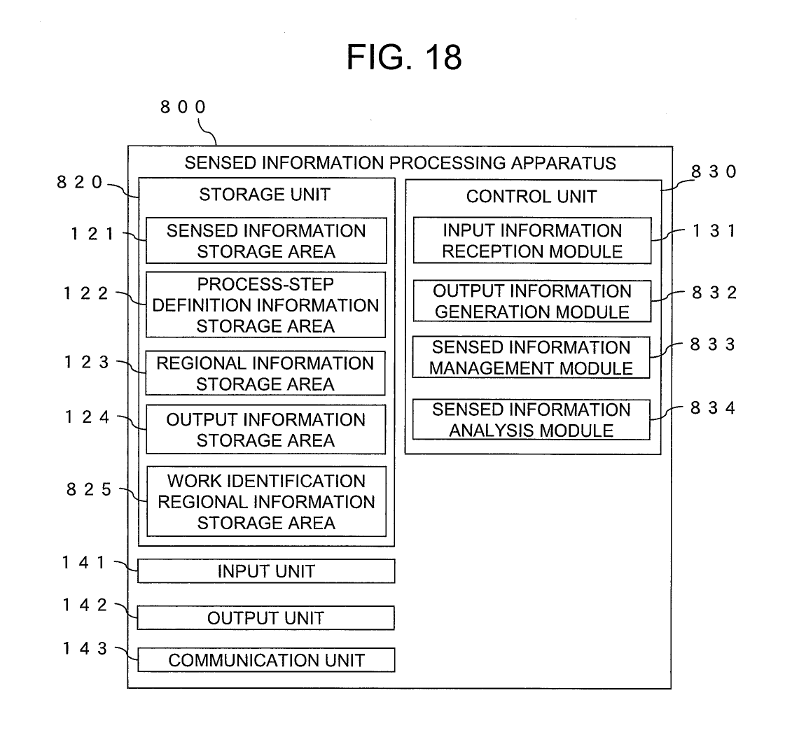

Next, FIGS. 18 to 22 are referenced to describe the fourth embodiment of the present invention.

A sensed information processing apparatus 800 according to the fourth embodiment of the present invention is, in principle, the same as the sensed information processing apparatus 100 according to the first embodiment, and hence the following description is directed to different points therebetween.

FIG. 18 is a schematic diagram illustrating the sensed information processing apparatus 800 according to the fourth embodiment of the present invention.

A storage unit 820 includes a work identification regional information storage area 825 in addition to the storage areas according to the first embodiment.

The work identification regional information storage area 825 stores a detailed region table 860.

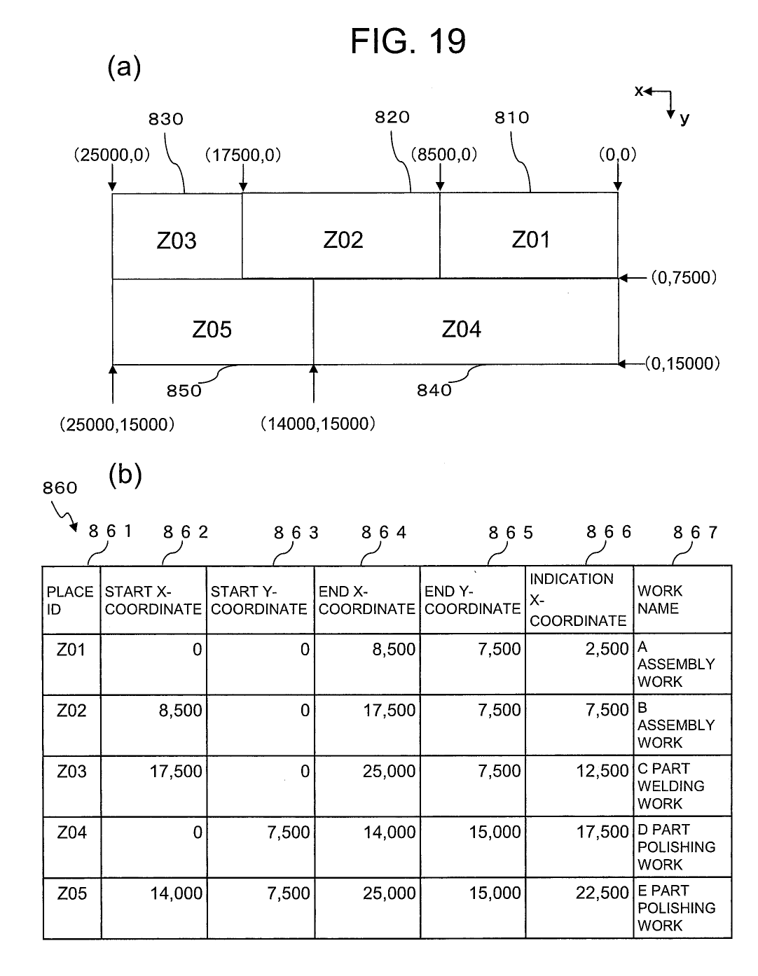

FIG. 19(a) is a diagram illustrating in detail the arrangement concerning an A01 region of the first process-step work region 211 of the workplace 2 illustrated in FIG. 6.

A Z01 detailed region 810 is a region surrounded by the point expressed by (0,0), a point expressed by (8500,7500), a point expressed by (0,7500), and a point expressed by (8500,0).

A Z02 detailed region 820 is a region surrounded by the point expressed by (8500,0), a point expressed by (17500,7500), the point expressed by (8500,7500), and a point expressed by (17500,0).

A Z03 detailed region 830 is a region surrounded by the point expressed by (17500,0), a point expressed by (25000,7500), the point expressed by (17500,7500), and a point expressed by (25000,0).

A Z04 detailed region 840 is a region surrounded by the point expressed by (0,7500), a point expressed by (14000,15000), a point expressed by (0,15000), and a point expressed by (14000,7500).

A Z05 detailed region 850 is a region surrounded by the point expressed by (14000,7500), a point expressed by (25000,15000), the point expressed by (14000,15000), and the point expressed by (25000,7500).

Based on such a detailed arrangement as illustrated in FIG. 19(a), FIG. 19(b) illustrates the detailed region table 860 that stores information that defines an area of each of the detailed regions by coordinates of two vertices connected by a diagonal line of each of the detailed regions.

The detailed region table 860 includes a place ID field 861, a start X-coordinate field 862, a start Y-coordinate field 863, an end X-coordinate field 864, an end Y-coordinate field 865, and a work name field 866.

The place ID field 861 stores a place ID as information that identifies the detailed region.

The start X-coordinate field 862 stores information regarding the X-coordinate of a first vertex being one vertex of two vertices that are opposed to each other across a diagonal line of the detailed region.

The start Y-coordinate field 863 stores information regarding the Y-coordinate of the first vertex of the detailed region.

The end X-coordinate field 864 stores information regarding the X-coordinate of a second vertex opposed to the first vertex across the diagonal line of the detailed region.

The end Y-coordinate field 865 stores information regarding the Y-coordinate the second vertex.

The indication X-coordinate field 866 stores information regarding the coordinate that determines the display position on the screen used to indicate the position or the like of the product or the worker on a detailed display screen 950 described later.

The work name field 867 stores a name of the work carried out in the region determined by the value stored in the place ID field 861. For example, if the value of the place ID field 861 is “Z01” and the value of the work name field 867 is “A assembly work”, it is understood that the “Z01” detailed region is the detailed region in which “A assembly work” is carried out.

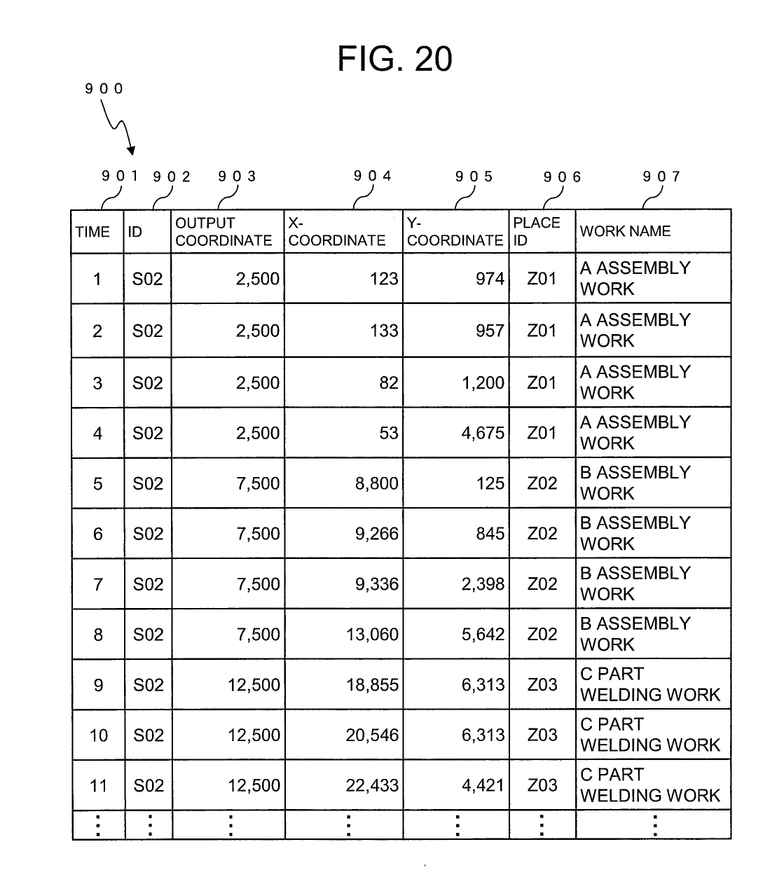

In the fourth embodiment, an output information table stored in the output information storage area 124 of the storage unit 820 is an output information table 900 illustrated in FIG. 20.

The output information table 900 includes a time field 901, an ID field 902, an output coordinate field 903, an X-coordinate field 904, a Y-coordinate field 905, a place ID field 906, and a work name field 907.

The time field 901 stores information that determines a time instant at which the detection value detected by the sensor 161 is detected. In this embodiment, information that determines a time instant at which the detection value detected by the sensor 161 is received is stored.

The ID field 902 stores information that determines an ID being identification information for identifying the worker or the work target product to which the sensor 161 is attached.

The output coordinate field 903 stores information that determines an output coordinate used when the position of the worker or the work target product to which the sensor 161 is attached is displayed on a screen.

The X-coordinate field 904 stores a value regarding the X-coordinate of the detection value detected by the sensor 161 determined by the ID field 902.

The Y-coordinate field 905 stores a value regarding the Y-coordinate of the detection value detected by the sensor 161 determined by the ID field 902.

The place ID 906 stores a place ID that indicates the detailed region determined from the coordinates stored in the X-coordinate field 904 and the Y-coordinate field 905.

The work name 907 stores a name of the work performed in the place ID stored in the place ID 906.

The control unit 830 includes an output information generation module 832, a sensed information management module 833, and a sensed information analysis module 834, in addition to the same input information reception module 131 as in the first embodiment.

The output information generation module 832 forms an output screen by combining information to be output and a screen layout, and makes the output unit 142 to display the output screen.

The sensed information management module 833 performs a processing which stores the detection value received from each of the sensors 161 via the communication unit 143 described later in the sensed information table 200 and the output information table 900.

It should be noted that the sensed information management module 833 stores a correlation between the sensor ID of the sensor 161 and the ID for identifying the worker, and stores an ID corresponding to the sensor ID attached to a measured value received from the sensor 161 in the ID field 202 of the sensed information table 200, and the ID field 902 of the output information table 900.

Further, the sensed information management module 833 stores the time instant at which the measured value is received in a region (not shown) of the storage unit 820.

In the same manner as the sensed information analysis module 134 of the first embodiment, the sensed information analysis module 834 uses the information stored in the sensed information table 200 to determine which process step, a target to which the sensor 161 is attached is in, for each of the sensors 161.

In addition, the sensed information analysis module 834 reads the value of the X-coordinate field 904 and the Y-coordinate field 905 of the output information table 900, and, from among records stored in the detailed region table 860, determines a record in which the read X-coordinate exists between the value of the start X-coordinate field 862 and the value of the end X-coordinate field 864 and in which the read Y-coordinate exists between the value of the start Y-coordinate field 863 and the value of the end Y-coordinate field 865.

Then, the sensed information analysis module 834 determines the place ID stored in the corresponding place ID field 861, coordinate information stored in the indication X-coordinate field 866, and a work name stored in the work name field 867 of the determined record.

Then, the sensed information analysis module 834 stores the place ID, the coordinate information, and the work name in the place ID field 906, the output coordinate field 903, and the work name field 907 of the output information table 900, respectively.

In the same manner as in FIG. 8, a hardware configuration of the sensed information processing apparatus 800 according to the fourth embodiment is a computer such as a client PC, a workstation, a server device, each of various mobile phone terminals, or a PDA.

The input information reception module 131, the output information generation module 832, the sensed information management module 833, and the sensed information analysis module 834 of the sensed information processing apparatus 800 are implemented by programs that make the arithmetic operation device 113 of the sensed information processing apparatus 800 to perform processings.

Those programs, which are stored within the main memory device 114 or the external storage device 115, are loaded onto the main memory device 114 before the execution thereof, and executed by the arithmetic operation device 113.

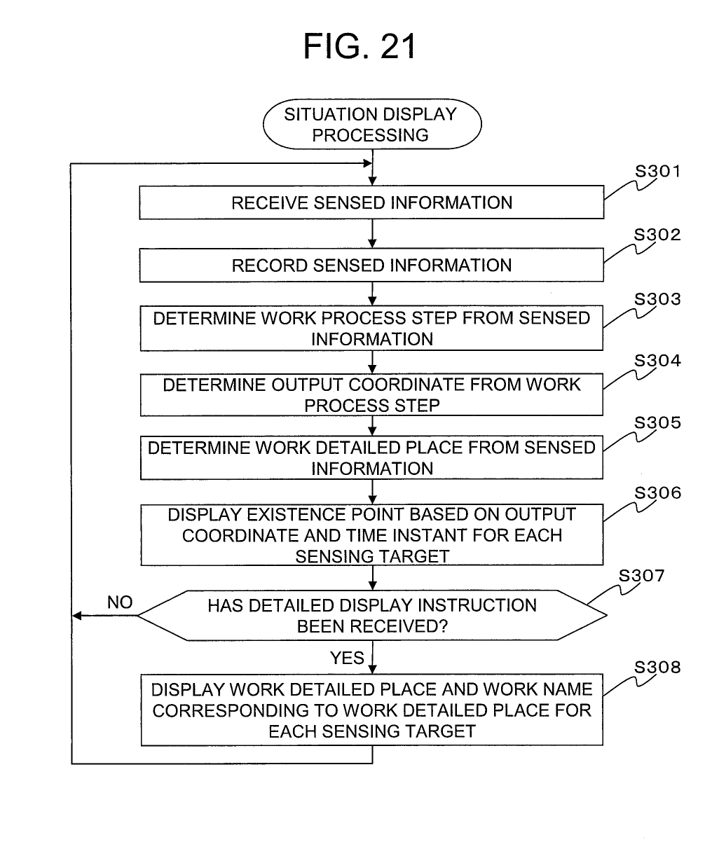

FIG. 21 illustrates a processing flow of a situation display processing according to the fourth embodiment.

First, the sensed information management module 833 receives the detection value transmitted from the sensor 161 via the communication unit 143 at predetermined intervals (for example, every one second) (Step S301).

Subsequently, the sensed information management module 833 stores the detection values received in Step S301 in the sensed information table 200 and the output information table 900 (Step S302).

Specifically, the sensed information management module 833 stores the detection values received in Step S301 in the X-coordinate field 203 and the Y-coordinate field 204 of the sensed information table 200 and the X-coordinate field 904 and the Y-coordinate field 905 of the output information table 900.

Subsequently, the sensed information analysis module 834 determines a work process step from sensed information (Step S303).

Specifically, the sensed information analysis module 834 reads the values of the X-coordinate field 904 and the Y-coordinate field 905 of the output information table 900.

Then, from among the records stored in the region table 450, the sensed information analysis module 834 determines a record in which the read X-coordinate exists between the value of the start X-coordinate field 452 and the value of the end X-coordinate field 454 and in which the read Y-coordinate exists between the value of the start Y-coordinate field 453 and the value of the end Y-coordinate field 455.

Then, the sensed information analysis module 834 determines the process-step ID stored in the corresponding process-step ID field 456 of the determined record.

Subsequently, the sensed information analysis module 834 determines the output coordinate from the process-step ID of the work process step determined in Step S303 (Step S304).

Specifically, from among the records stored in the process-step definition table 300, the sensed information analysis module 834 determines the values of the process-step name field 303 and the indication X-coordinate field 305 of the record in which the process-step ID determined in Step S303 matches the value of the process-step ID field 301 within the process-step definition table 300.

Then, the sensed information analysis module 834 stores the information on the determined process-step name and the information on the indication X-coordinate in the process step field 503 and the output coordinate field 504, respectively, of the output information table 500.

Subsequently, the sensed information analysis module 834 determines a work detailed place from the sensed information (Step S305).

Specifically, the sensed information analysis module 834 reads the values of the X-coordinate field 904 and the Y-coordinate field 905 of the output information table 900.

Then, from among records stored in the detailed region table 860, the sensed information analysis module 834 determines a record in which the read X-coordinate exists between the value of the start X-coordinate field 862 and the value of the end X-coordinate field 864 and in which the read Y-coordinate exists between the value of the start Y-coordinate field 863 and the value of the end Y-coordinate field 865.

Then, the sensed information analysis module 834 determines the place ID stored in the corresponding place ID field 861, the coordinate information stored in the indication X-coordinate field 866, and the work name stored in the work name field 867 of the determined record.

Then, the sensed information analysis module 834 stores the place ID, the coordinate information, and the work name in the place ID field 906, the output coordinate field 903, and the work name field 907 of the output information table 900, respectively.

Subsequently, the output information generation module 832 uses the information within the output information table 500 to form and display a screen (Step S306).

Specifically, with regard to the records of the output information table 500, the output information generation module 832 displays points in display positions determined by the output coordinate field 504 in ascending order of the values of the time field 501 for each value of the ID field 502, to thereby form and display the situation display screen 550 illustrated in FIG. 10.

Subsequently, the sensed information analysis module 834 judges whether or not an instruction for detailed display has been received on the situation display screen 550 (Step S307).

Specifically, the sensed information analysis module 834 judges whether or not the instruction for detailed display has been received by inquiring of the input information reception module 131 on whether or not a detailed display instruction that specifies the specific process step within the process-step display field 551 of the situation display screen 550 has been received.

If the instruction for detailed display has not been received (“No” in Step S307), the sensed information management module 833 returns the processing to Step S301, and receives the sensed information.

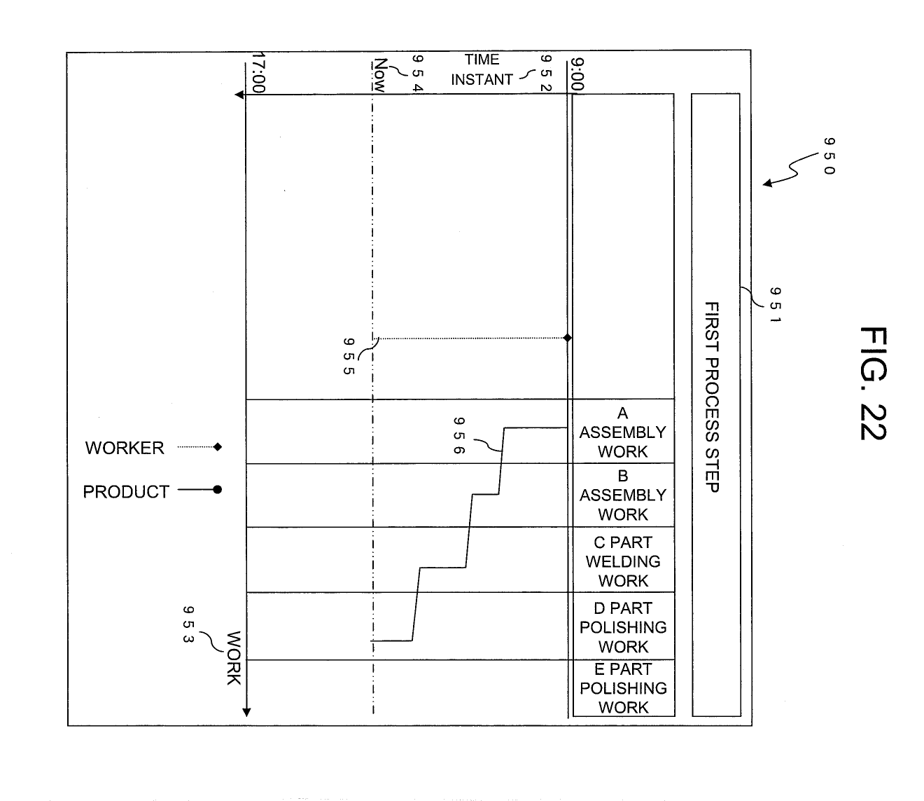

If the instruction for detailed display has been received (“Yes” in Step S307), with regard to the records of the output information table 900, the output information generation module 832 displays the points in the display positions determined by the output coordinate field 903 in ascending order of the values of the time field 901 for each value of the ID field 902 with regard to the process step for which the instruction has been received, to thereby form and display the detailed display screen 950 illustrated in FIG. 22.

In this case, when a sensing target moves to a different work, the output information generation module 832 performs the displaying by adding an oblique line connecting the previous point in the work before the movement to the point after the movement.

FIG. 22 is a diagram illustrating an example of the detailed display screen 950.

The detailed display screen 950 includes a process-step display field 951, a time instant axis line 952, a work axis line 953, a present time instant indicating line 954, a worker position indicating line 955, and a product position indicating line 956.

The process-step display field 951 includes display fields in order of work with regard to the works of the process step of the specified display target. In FIG. 22, the process-step display field 951 includes display fields of “A assembly work”, “B assembly work”, “C part welding work”, “D part polishing work”, and “E part polishing work” from the left to the right of the screen.

The respective display fields of the process-step display field 951 correspond to the Z01 detailed region 810, the Z02 detailed region 820, the Z03 detailed region 830, the Z04 detailed region 840, and the Z05 detailed region 850 with regard to the first process-step work region 211 of the workplace 2.

It should be noted that the value of the indication X-coordinate field 866 of the detailed region table 860 and the value of the output coordinate field 903 of the output information table 900 are values that determine the coordinates in a horizontal position around the center of the respective work fields of the process-step display field 951.

Further, the display breadths of the respective work fields of the process-step display field 951 may be set to be proportionate to the lengths of the detailed regions in terms of the layout, or may be simply set as regular intervals.

The time instant axis line 952, which serves as a vertical axis directed downward from the top of the detailed display screen 950, indicates a flow of the time instant.

The work axis line 953, which serves as a horizontal axis directed rightward from the left of the detailed display screen 950, indicates a flow of the work.

The present time instant indicating line 954 indicates a time instant corresponding to the present time instant on the time instant axis line 952.

The worker position indicating line 955 is a line that connects points indicating the positions on a time-by-time basis of the sensor 161 attached to the worker.

The product position indicating line 956 is a line that connects points indicating the positions on a time-by-time basis of the sensor 161 attached to the product of the work target or the like.

In other words, for example, if the worker of the sensing target exists in the first process-step work region 211, the situation display screen 950 displays the point in the position corresponding to the detected time instant in the left side portion or at the center of the process-step display f field 951, and displays the points, which are recorded from the start of detection until the present time instant, as the worker position indicating line 955.

Further, if the product or the worker of the sensing target exists in the Z01 detailed region 810 of the first process-step work region 211, the detailed display screen 950 displays the point in the position corresponding to the detected time instant within the corresponding work field in the right side portion of the process-step display field 951, and displays the points, which are recorded from the start of detection until the present time instant, as the product position indicating line 956.

Then, the detected information management module 133 returns the processing to Step S301, and receives the sensed information.

The flow of the situation display processing in the fourth embodiment has been described above.

According to the fourth embodiment of the present invention, in the same manner as the sensed information processing apparatus 100 according to the first embodiment, the sensed information processing apparatus 800 can detect the positions of the worker and the product being the sensing targets, determine the process step and the time instant, and use the situation display screen 550 to present the process step and the passage of time in the form of an at-a-glance chart. Further, in addition thereto, the sensed information processing apparatus 800 can detect the further detailed positions of the worker and the product being the sensing targets, determine the work and the time instant within the process step, and use the detailed display screen 950 to present the work and the passage of time within the process step in the form of an at-a-glance chart.

The specific descriptions have been made above based on the first to fourth embodiments, but the present invention is not limited thereto, and various changes can be made thereto without departing from the gist thereof.

For example, when the sensed information is received from the sensor 161 in Step S004 of the sensing processing according to the above-mentioned first embodiment, the received detection value may be used by eliminating a high-frequency component from the detection value instead of being used as it is.

With this configuration, the sensed information exhibiting little noise can be recorded.

Further, when the sensed information is received from the sensor 161 in Step S201 of the sensing processing according to the above-mentioned first embodiment, the detection values of the X-axis, the Y-axis, and the Z-axis may be received as the magnitude of a vector obtained by combining the detection values of the X-axis, the Y-axis, and the Z-axis instead of being received as it is.

With this configuration, it is possible to reduce a processing load that occurs when the calculation is performed by combining the accelerations in Step S204.

Further, when the process step and the passage of time are displayed in Step S005 of the situation display processing according to the above-mentioned first embodiment, a locus of the worker or the product of the sensing target may be additionally displayed over layout information on the workplace 2.

With this configuration, it is possible to figure out a concrete image of the situation of the workplace 2 while reviewing the process step and the passage of time.

Further, the sensed information processing apparatus 100 or 800 is configured to operate on a standalone basis, but the present invention is not limited thereto, and may serve as, for example, a server device which provides a service via a communication protocol such as a hyper text transfer protocol (HTTP) to receive an input instruction from another terminal device via a network and make the terminal device to display an output.

With such changes, the user becomes capable of operating the sensed information processing apparatus 100 or 800 through another terminal connected to the network, and it is possible to enhance the degree of freedom of the equipment configuration and the convenience of the user.

Further, in the above-mentioned first embodiment to fourth embodiment, the sensed information processing apparatus 100 receives the information transmitted from the sensor 161 and determines the process step or a detailed work at which the sensor 161 is located, but the present invention is not limited thereto as long as the sensed information processing apparatus 100 can receive such information as to determine the process step or the detailed work.

For example, a sensing device mounted for each process step or each detailed work may sense the radio wave transmitted by a radio wave transmitting device attached to the target worker and transmit the identification information on the worker and information that identifies the sensing device to the sensed information processing apparatus 100, and the sensed information processing apparatus 100 may determine the process step and the detailed work by the information that identifies the sensing device.

With this configuration, the sensor 161 can be easily downsized.

Further, the works to be sensed are not limited to the works within a factory as illustrated by the workplace 2, but can include various works and actions such as works in a kitchen of a restaurant or actions of a player in a sports game.

It should be noted that the sensed information processing apparatus 100 or 800 is not only to be dealt as an apparatus, but can also be dealt in units of program components that implement operations of the apparatus.

Next described is the fifth embodiment for determining a work content without forcing the worker into a special operation.

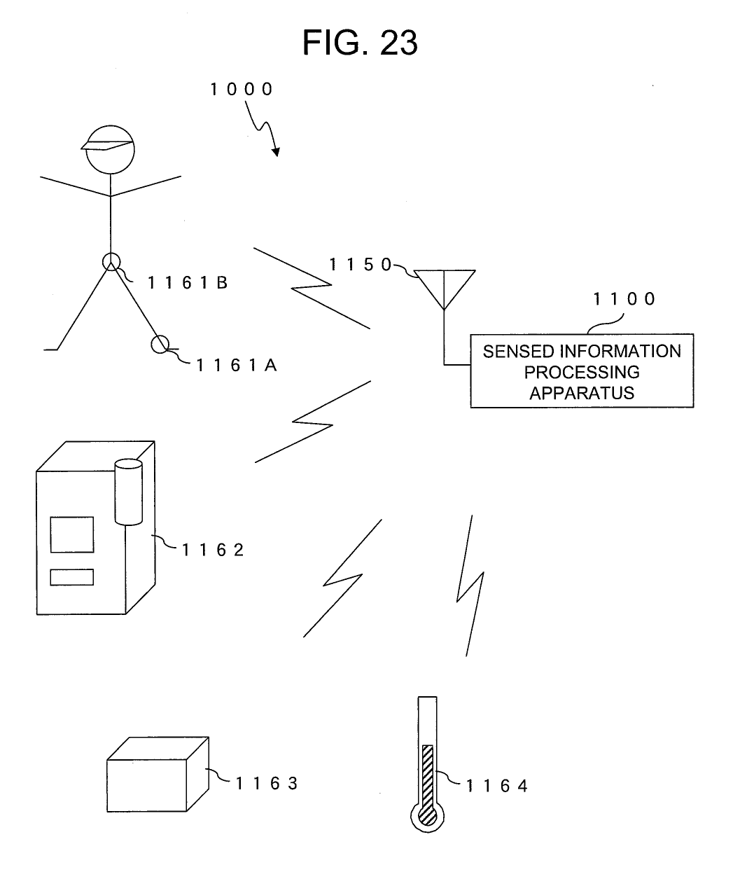

FIG. 23 is a diagram illustrating a work information processing system 2000 according to the fifth embodiment of the present invention.

The work information processing system 2000 according to this embodiment includes a worker sensor 1161A and a worker sensor 1161B (hereinafter, referred to as “worker sensor 1161” in a case where the individual worker sensors are not particularly distinguished from each other) that are attached to a worker, an apparatus sensor 1162 attached to a processing apparatus, a product sensor 1163 attached to a product, an environment sensor 1164 mounted in a workplace or the like which measures a temperature and a humidity, and a sensed information processing apparatus 1100.

The worker sensor 1161 is a sensor which detects an action and a position of a person to which the worker sensor 1161 is attached. In this embodiment, the worker sensor 1161 has a function of an acceleration sensor which measures the accelerations of three orthogonal directions (set as X-direction, Y-direction, and Z-direction) and a position sensor such as a global positioning system (GPS) which measures the position within the work region on a plane (two dimensions of the X-coordinate and the Y-coordinate).

It should be noted that the worker sensor 1161 detects the acceleration including the gravitational acceleration in units of 1/1,000 G. However, the present invention is not limited thereto, and the worker sensor 1161 may, for example, detect the detection value by canceling a gravitational acceleration component.

Naturally, the worker sensor 1161 is not limited to the acceleration sensor or the position sensor, and may be any sensor which can detect the action and the position of the person to which the sensor is attached, for example, may be an oximeter sensor which can detect an oxygen concentration in the blood of the person to which the sensor is attached, a temperature sensor, a current sensor, or the like.

It should be noted that in FIG. 23, the worker sensor 1161A is attached to the worker's left foot, and the worker sensor 1161B is attached to his/her waist, but the present invention is not limited to such a mode, and any mode can be employed as long as actions at a plurality of sites of the worker can be detected by a plurality of worker sensors 1161.

Further, the worker sensor 1161 transmits the detection value to the sensed information processing apparatus 1100 via radio.

The apparatus sensor 1162 is a sensor which detects an operational status of the processing apparatus being a tool for work to which the apparatus sensor 1162 is attached. In this embodiment, the apparatus sensor 1162 is a voltage sensor which measures a voltage applied to the processing apparatus, a gas flow sensor of a welding apparatus, or the like.

It should be noted that the apparatus sensor 1162 is not limited to the voltage sensor or the gas flow sensor, and may be any sensor which can detect the operational status of an apparatus to which the sensor is attached, for example, may be the temperature sensor which can detect heat generated by the apparatus to which the sensor is attached or the like.

Further, the apparatus sensor 1162 transmits the detection value to the sensed information processing apparatus 1100 via radio.

The product sensor 1163 is a sensor which detects the work being performed on the work target product to which the product sensor 1163 is attached and the position. In this embodiment, the product sensor 1163 has a function of the acceleration sensor which measures the accelerations of the three orthogonal directions (set as X-direction, Y-direction, and Z-direction) regarding a target product and the position sensor such as a global positioning system (GPS) which measures the position within the work region on a predetermined plane (two dimensions of the X-coordinate and the Y-coordinate).

It should be noted that the product sensor 1163 is not limited to the acceleration sensor or the position sensor, and may be any sensor which can detect the work being performed on the product to which the sensor is attached and the position of the product, for example, may be the temperature sensor which can detect heat generated by the apparatus to which the sensor is attached or the like.

Further, the product sensor 1163 transmits the detection value to the sensed information processing apparatus 1100 via radio.

The environment sensor 1164 is a sensor which detects environmental information on the workplace in which the environment sensor 1164 is attached. In this embodiment, the environment sensor 1164 is the temperature sensor which measures a temperature of the workplace, a humidity sensor which measures a humidity of the workplace, or the like.

It should be noted that the environment sensor 1164 is not limited to the temperature sensor or the humidity sensor, and may be any sensor which can detect the situation of the environment in which the sensor is attached, for example, may be an illuminance sensor which can detect a brightness of the workplace in which the sensor is attached or the like.

Further, the environment sensor 1164 transmits the detection value to the sensed information processing apparatus 1100 via radio.

The sensed information processing apparatus 1100 uses an antenna 1150 to receive the respective detection values transmitted from the worker sensor 1161, the apparatus sensor 1162, the product sensor 1163, and the environment sensor 1164.

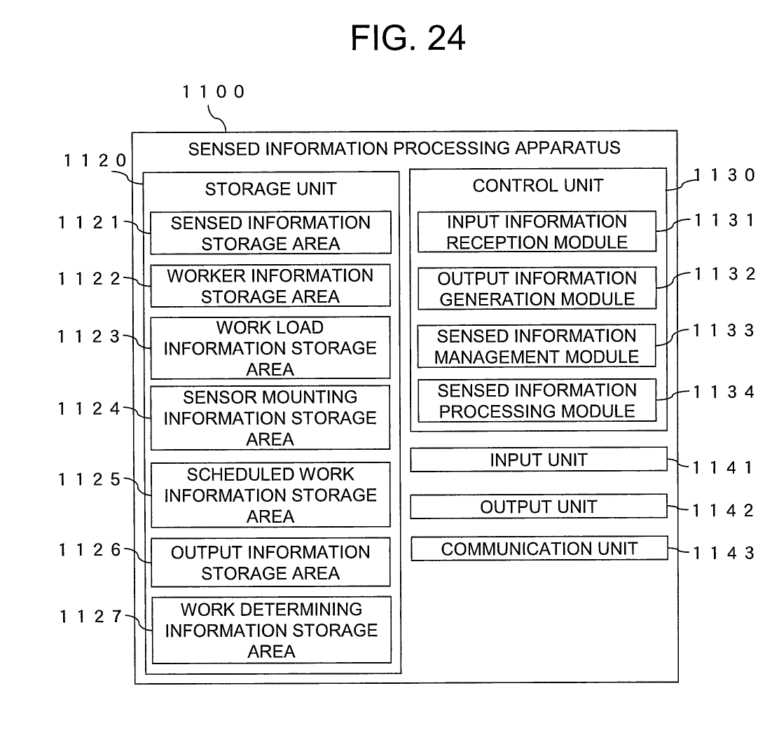

FIG. 24 is a schematic diagram of the sensed information processing apparatus 1100.

As illustrated in the figure, the sensed information processing apparatus 1100 includes a storage unit 1120, a control unit 1130, an input unit 1141, an output unit 1142, and a communication unit 1143.

The storage unit 1120 includes a sensed information storage area 1121, a worker information storage area 1122, a work load information storage area 1123, a sensor mounting information storage area 1124, a scheduled work information storage area 1125, an output information storage area 1126, and a work determining information storage area 1127.

The sensed information storage area 1121 stores a worker sensed information table 1200, an apparatus sensed information table 1250, an apparatus sensed information table 1300, and an environment sensed information table 1350.

The worker sensed information table 1200 stores information sensed from the worker sensor 1161. The apparatus sensed information table 1250 stores information sensed from the apparatus sensor 1162. The apparatus sensed information table 1300 stores information sensed from the product sensor 1163. The environment sensed information table 1350 stores information sensed from the environment sensor 1164.

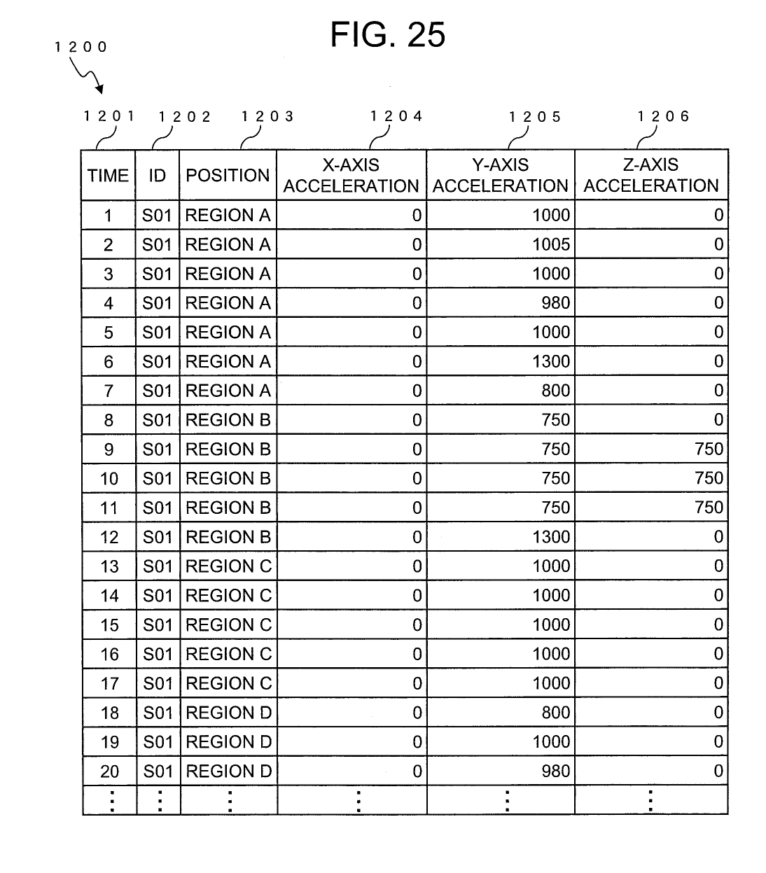

FIG. 25 illustrates a structure example of the worker sensed information table 1200.

The worker sensed information table 1200 includes a time field 1201, an ID field 1202, a position field 1203, an X-axis acceleration field 1204, a Y-axis acceleration field 1205, and a Z-axis acceleration field 1206.

The time field 1201 stores the information that determines the time instant at which the detection value detected by the worker sensor 1161 is detected. In this embodiment, information that determines the time instant at which the detection value detected by the worker sensor 1161 is received by the sensed information processing apparatus 1100 is stored as the information that determines the time instant at which the detection value detected by the worker sensor 1161 is detected.

It should be noted that by setting the detection value to be periodically transmitted from the worker sensor 1161 and managing a specific time instant so as to correspond to the value stored in the time field 1201 in the sensed information processing apparatus 1100, it is possible to determine the time instant of each record. For example, “1”, “2”, “3”, . . . , and “n” correspond to the detection values in “2 seconds after”, “4 seconds after”, “6 seconds after”, . . . , and “2n seconds after” the start of recording, respectively.

The ID field 1202 stores an ID of the worker being identification information for identifying the worker to which the worker sensor 1161 is attached.

In this embodiment, one worker ID is assigned to the worker sensor 1161 attached to one worker.

The position field 1203 stores a value that determines a region including the position detected by the worker sensor 1161 attached to the worker determined by the ID field 1202.

The X-axis acceleration field 1204 stores the value of the X-axis of the detection value of the acceleration detected by the worker sensor 1161 attached to the worker determined by the ID field 1202.

The Y-axis acceleration field 1205 stores the value of the Y-axis of the detection value of the acceleration detected by the worker sensor 1161 attached to the worker determined by the ID field 1202.

The Z-axis acceleration field 1206 stores the value of the Z-axis of the detection value of the acceleration detected by the worker sensor 1161 attached to the worker determined by the ID field 1202.

It should be noted that by attaching the sensor ID being identification information uniquely assigned to each sensor to the detection value transmitted from the worker sensor 1161, the sensed information processing apparatus 1100 can manage the worker ID corresponding to the sensor ID and store the detection value detected by the worker sensor 1161 in the corresponding position field 1203, X-axis acceleration field 1204, Y-axis acceleration field 1205, and Z-axis acceleration field 1206.

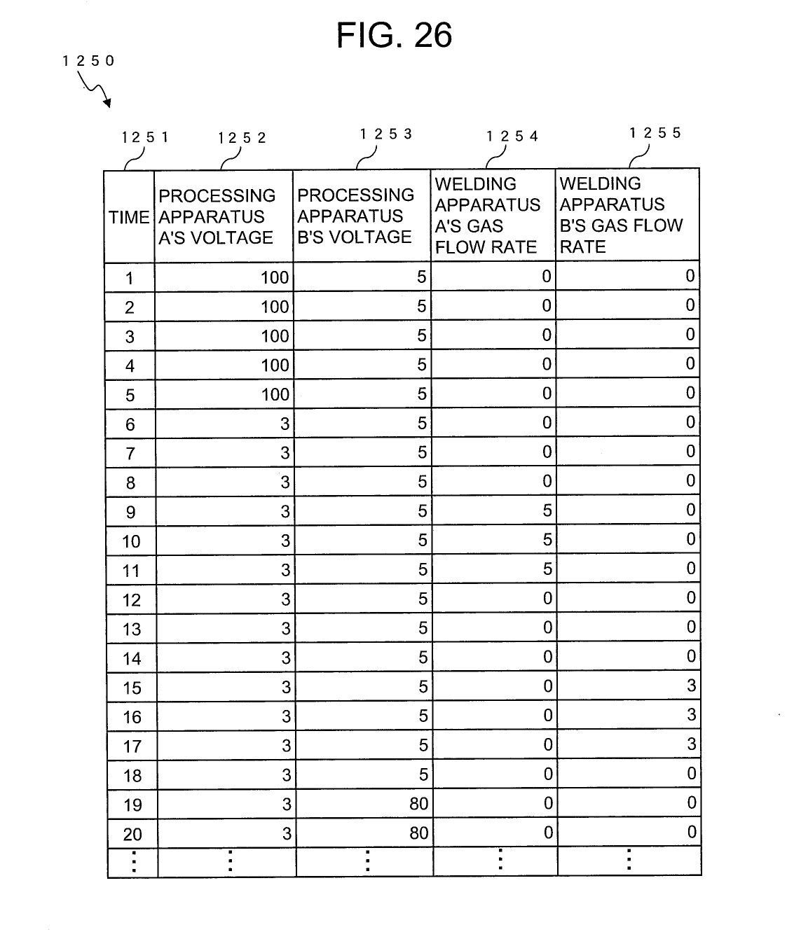

FIG. 26 illustrates a structure example of the apparatus sensed information table 1250.

The apparatus sensed information table 1250 includes a time field 1251, a processing apparatus A's voltage field 1252, a processing apparatus B's voltage field 1253, a welding apparatus A's gas flow rate field 1254, and a welding apparatus B's gas flow rate field 1255.

The time field 1251 stores the information that determines the time instant at which the detection value detected by the apparatus sensor 1162 is detected. In this embodiment, information that determines the time instant at which the detection value detected by the apparatus sensor 1162 is received by the sensed information processing apparatus 1100 is stored as the information that determines the time instant at which the detection value detected by the apparatus sensor 1162 is detected.

It should be noted that by setting the detection value to be periodically transmitted from the apparatus sensor 1162 and managing a specific time instant so as to correspond to the value stored in the time field 1251 in the sensed information processing apparatus 1100, it is possible to determine the time instant of each record. For example, “1”, “2”, “3”, . . . , and “n” correspond to the detection values in “2 seconds after”, “4 seconds after”, “6 seconds after”, . . . , and “2n seconds after” the start of recording, respectively.

The processing apparatus A's voltage field 1252 stores information that determines a voltage detected in the processing apparatus A to which the apparatus sensor 1162 is attached.

The processing apparatus B's voltage field 1253 stores information that determines a voltage detected in the processing apparatus B to which the apparatus sensor 1162 is attached.

The welding apparatus A's gas flow rate field 1254 stores information that determines a gas flow rate detected in the welding apparatus A to which the apparatus sensor 1162 is attached.

The welding apparatus B's gas flow rate field 1255 stores information that determines a gas flow rate detected in the welding apparatus B to which the apparatus sensor 1162 is attached.

In this embodiment, one sensor ID is assigned to the apparatus sensor 1162 attached to each apparatus.

It should be noted that the sensor ID being the identification information uniquely assigned to each sensor is attached to the detection value transmitted from the apparatus sensor 1162, and hence the sensed information processing apparatus 1100 can use a sensor mounting table 1500 described later to manage the apparatus corresponding to the sensor ID and store the detection value detected by the apparatus sensor 1162 in the field indicating the corresponding apparatus.

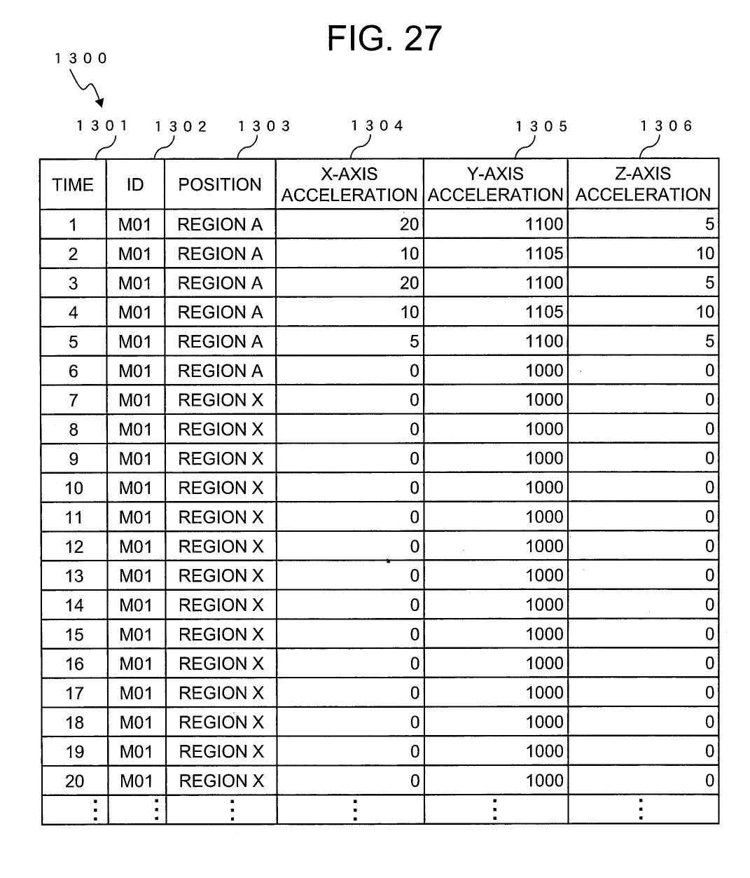

FIG. 27 illustrates a structure example of the product sensed information table 1300.

The product sensed information table 1300 includes a time field 1301, an ID field 1302, a position field 1303, an X-axis acceleration field 1304, a Y-axis acceleration field 1305, and a Z-axis acceleration field 1306.

The time field 1301 stores the information that determines the time instant at which the detection value detected by the product sensor 1163 is detected. In this embodiment, information that determines the time instant at which the detection value detected by the product sensor 1163 is received by the sensed information processing apparatus 1100 is stored as the information that determines the time instant at which the detection value detected by the product sensor 1163 is detected.

It should be noted that by setting the detection value to be periodically transmitted from the product sensor 1163 and managing a specific time instant so as to correspond to the value stored in the time field 1301 in the sensed information processing apparatus 1100, it is possible to determine the time instant of each record. For example, “1”, “2”, “3”, . . . , and “n” correspond to the detection values in “2 seconds after”, “4 seconds after”, “6 seconds after”, . . . , and “2n seconds after” the start of recording, respectively.

The ID field 1302 stores information that determines a product ID being identification information for identifying the product to which the product sensor 1163 is attached.

In this embodiment, one sensor ID is assigned to the product sensor 1163 attached to one product.

The position field 1303 stores a value that determines a region including the position detected by the product sensor 1163 attached to the product determined by the ID field 1302.

The X-axis acceleration field 1304 stores a value of the X-axis of the detection value of the acceleration detected by the product sensor 1163 attached to the product determined by the ID field 1302.

The Y-axis acceleration field 1305 stores the value of the Y-axis of the detection value of the acceleration detected by the product sensor 1163 attached to the product determined by the ID field 1302.

The Z-axis acceleration field 1306 stores the value of the Z-axis of the detection value of the acceleration detected by the product sensor 1163 attached to the product determined by the ID field 1302.

It should be noted that the sensor ID being the identification information uniquely assigned to each sensor is attached to the detection value transmitted from the product sensor 1163, and hence the sensed information processing apparatus 1100 can use the sensor mounting table 1500 described later to manage the product ID corresponding to the sensor ID and store the detection value detected by the product sensor 1163 in the corresponding position field 1303, X-axis acceleration field 1304, Y-axis acceleration field 1305, and Z-axis acceleration field 1306.

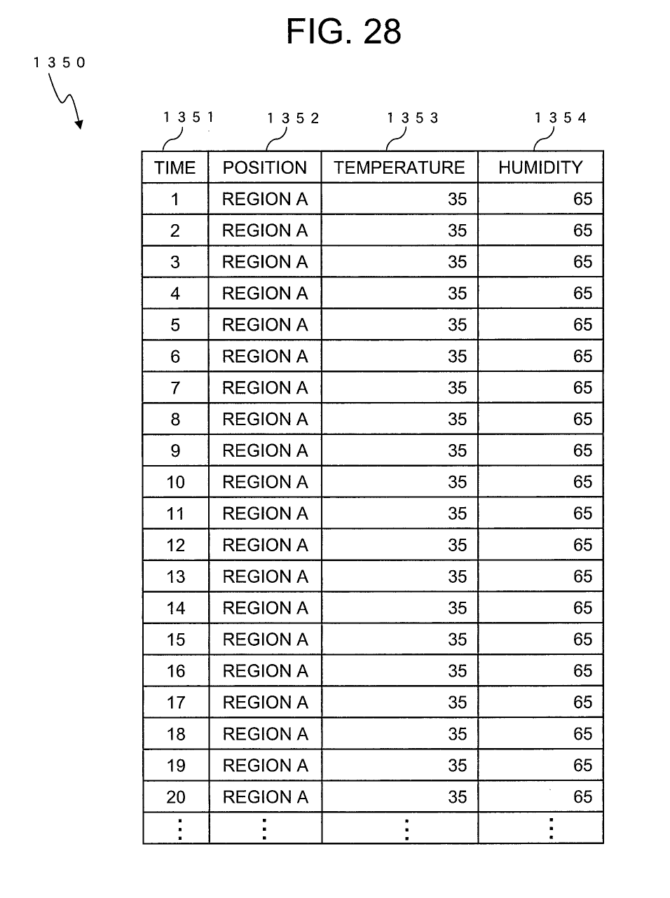

FIG. 28 illustrates a structure example of the environment sensed information table 1350.

The environment sensed information table 1350 includes a time field 1351, a position field 1352, a temperature field 1353, and a humidity field 1354.

The time field 1351 stores the information that determines the time instant at which the detection value detected by the environment sensor 1164 is detected. In this embodiment, information that determines the time instant at which the detection value detected by the environment sensor 1164 is received by the sensed information processing apparatus 1100 is stored as the information that determines the time instant at which the detection value detected by the environment sensor 1164 is detected.

It should be noted that by setting the detection value to be periodically transmitted from the environment sensor 1164 and managing a specific time instant so as to correspond to the value stored in the time field 1351 in the sensed information processing apparatus 1100, it is possible to determine the time instant of each record. For example, “1”, “2”, “3”, . . . , and “n” correspond to the detection values in “2 seconds after”, “4 seconds after”, “6 seconds after”, . . . , and “2n seconds after” the start of recording, respectively.

The position field 1352 stores a value that determines the region of the position in which the environment sensor 1164 is provided.

The temperature field 1353 stores a value that determines the detection value of the temperature detected by the environment sensor 1164.

The humidity field 1354 stores a value that determines the detection value of the humidity detected by the environment sensor 1164.

It should be noted that by attaching a sensor ID being identification information uniquely assigned to each sensor to the detection value transmitted from the environment sensor 1164, the sensed information processing apparatus 1100 can manage the region of the position corresponding to the sensor ID and store the detection value detected by the environment sensor 1164 in the temperature field 1353 and the humidity field 1354 corresponding to the value of the position field 1352.

Stored in the worker information storage area 1122 is a worker information table 1400 for storing the information regarding the worker.

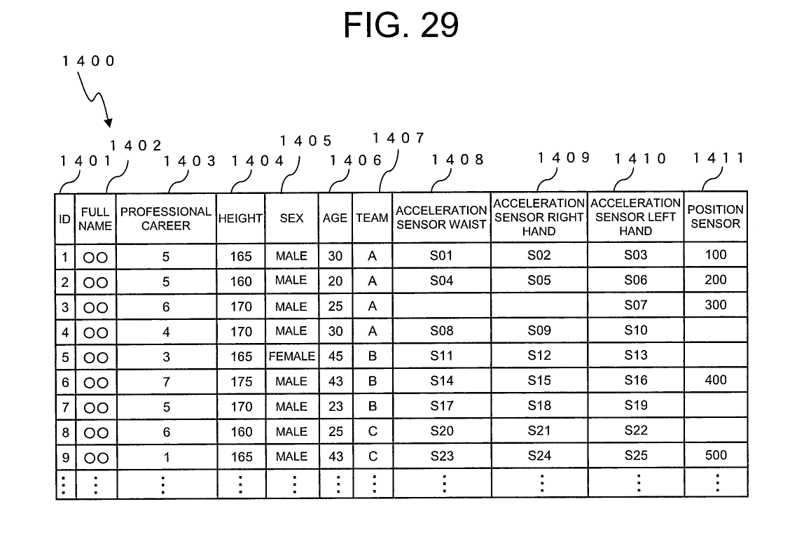

FIG. 29 illustrates a structure example of the worker information table 1400.

The worker information table 1400 includes an ID field 1401, a full name field 1402, a professional career field 1403, a height field 1404, a sex field 1405, an age field 1406, a team field 1407, an acceleration sensor waist field 1408, an acceleration sensor right hand field 1409, an acceleration sensor left hand field 1410, and a position sensor 1411.

The ID field 1401 stores the information that determines the worker ID being the identification information for identifying the worker to which the worker sensor 1161 is attached.

The full name field 1402 stores a full name of the worker determined by the ID field 1401.

The professional career field 1403 stores the information on professional career (years of employment) of the worker determined by the ID field 1401.

The height field 1404 stores the height of the worker determined by the ID field 1401.

The sex field 1405 stores the sex of the worker determined by the ID field 1401.

The age field 1406 stores the age of the worker determined by the ID field 1401 belongs.

The team field 1407 stores the information that determines a task-based team to which the worker determined by the ID field 1401 belongs.

The acceleration sensor waist field 1408 stores the sensor ID that identifies the worker sensor 1161 attached to the waist of the worker determined by the ID field 1401.

The acceleration sensor right hand field 1409 stores the sensor ID that identifies the worker sensor 1161 attached to the right hand of the worker determined by the ID field 1401.

The acceleration sensor left hand field 1410 stores the sensor ID that identifies the worker sensor 1161 attached to the left hand of the worker determined by the ID field 1401.

The position sensor field 1411 stores the sensor ID that identifies the worker sensor 1161 which senses the position of being attached to the worker determined by the ID field 1401.

Stored in the work load information storage area 1123 is a work load information table 1450.

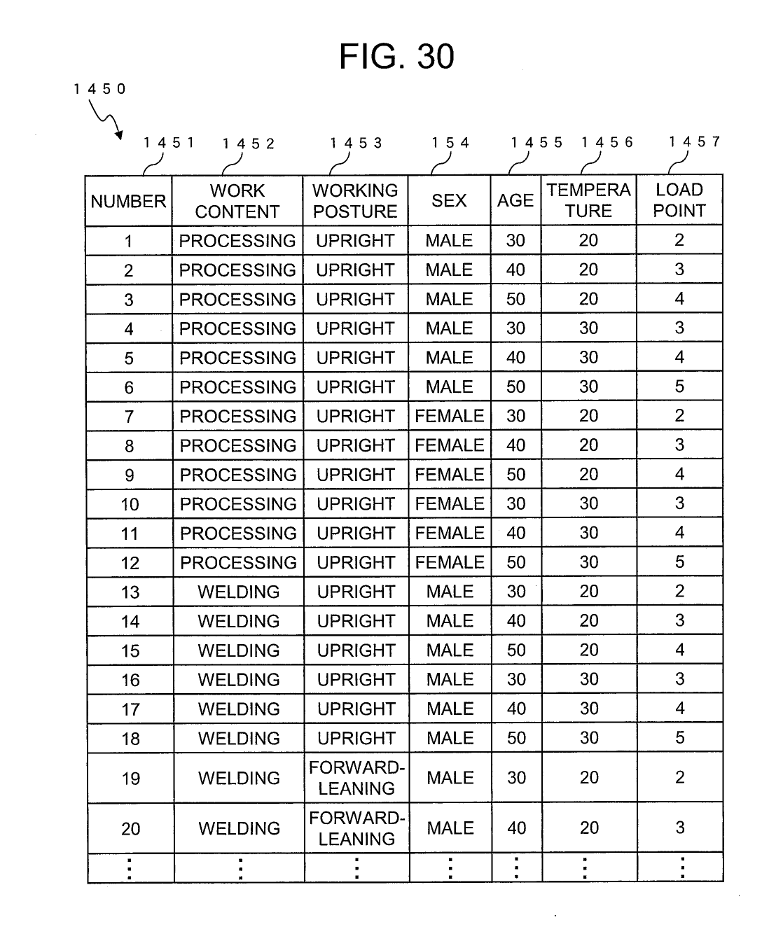

FIG. 30 illustrates a structure example of the work load information table 1450.

The work load information table 1450 includes a number field 1451, a work content field 1452, a working posture field 1453, a sex field 1454, an age field 1455, a temperature field 1456, and a load point field 1457.

The number field 1451 stores information that identifies the record stored in the work load information table 1450.

The work content field 1452 stores a value that identifies a work content (processing, welding, or the like) being performed by the worker.

The working posture field 1453 stores a value that identifies an (upright, forward-leaning, or the like) posture that the worker takes while working.

The sex field 1454 stores a value that identifies the sex of a person who is performing the work.

The age field 1455 stores the age of the person who is performing the work.

The temperature field 1456 stores the temperature of the environment in which the work is being performed.

The load point field 1457 stores a load point being a value based on which the load of the work is calculated. The larger the load point is, it is assumed that the heavier the load of the work being performed is.

Stored in the sensor mounting information storage area 1124 is the sensor mounting table 1500 for storing information that determines mounting situations of the apparatus sensor 1162 and the product sensor 1163.

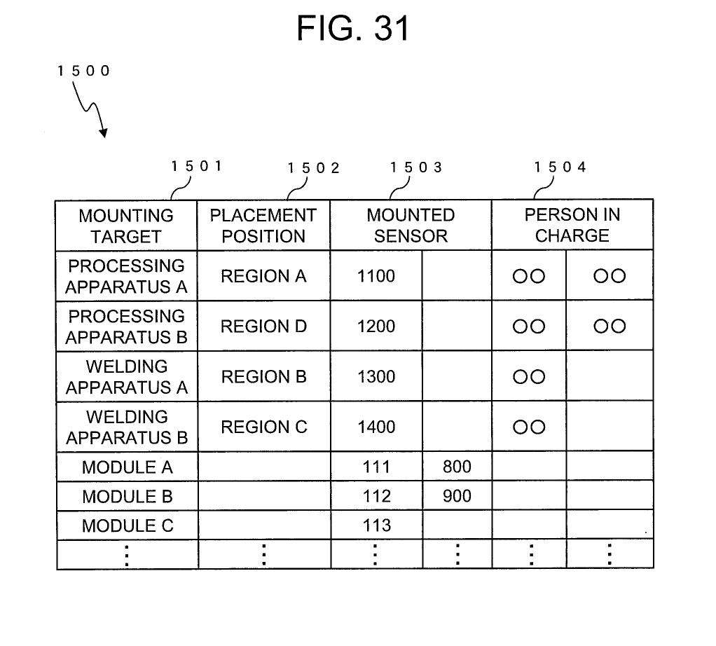

FIG. 31 illustrates a structure example of the sensor mounting table 1500.

The sensor mounting table 1500 includes a mounting target field 1501, a placement position field 1502, a mounted sensor field 1503, and a person-in-charge field 1504.

The mounting target field 1501 stores information that determines a target to be sensed by the sensor. In this embodiment, the information includes the processing apparatus and the welding apparatus that are tools used for the work or the product on which the work is performed.

The placement position field 1502 stores a value that determines the region including the position in which the target mounted with the sensor is placed.

The mounted sensor field 1503 stores information that identifies the sensor mounted to a mounting target. It should be noted that in a case where a plurality of sensors are mounted to the target, a plurality of values are stored in the mounted sensor field 1503.

The person-in-charge field 1504 stores information that determines a person in charge who uses the apparatus of the mounting target or a person in charge who manufactures the product of the mounting target. It should be noted that in a case where there are a plurality of persons in charge, the person-in-charge field 1504 stores a plurality of values.

Stored in the scheduled work information storage area 1125 is a scheduled work information table 1550 for storing a schedule of work.

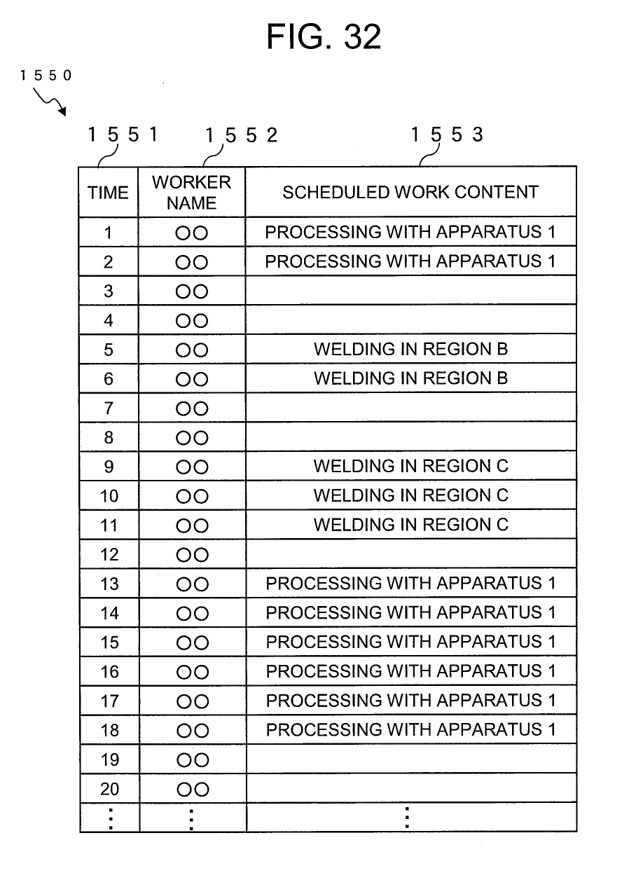

FIG. 32 illustrates a structure example of the scheduled work information table 1550.

The scheduled work information table 1550 includes a time field 1551, a worker name field 1552, and a scheduled work content field 1553.

The time field 1551 stores information that determines the time instant at which the work is performed.

The worker name field 1552 stores a name of the worker that identifies a person who performs the work.

The scheduled work content field 1553 stores information that determines the work content.

Stored in the output information storage area 1126 are a basic information table 1600 for storing basic information necessary for creating information to be output and an output information table 1700 for storing the information to be output.

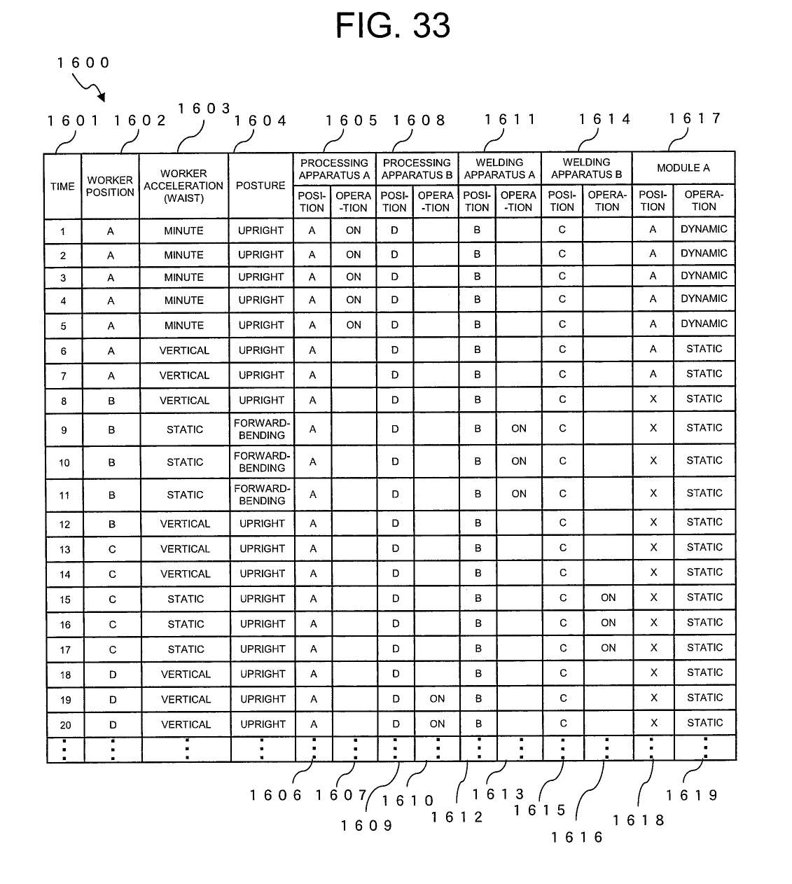

FIG. 33 illustrates a structure example of the basic information table 1600.

The basic information table 1600 includes a time field 1601, a worker position field 1602, a worker acceleration (waist) field 1603, a posture field 1604, an information field 1605 for the processing apparatus A, a position field 1606 for the processing apparatus A, an operation field 1607 for the processing apparatus A, an information field 1608 for the processing apparatus B, a position field 1609 for the processing apparatus B, an operation field 1610 for the processing apparatus B, an information field 1611 for the welding apparatus A, a position field 1612 for the welding apparatus A, an operation field 1613 for the welding apparatus A, an information field 1614 for the welding apparatus B, a position field 1615 for the welding apparatus B, an operation field 1616 for the welding apparatus B, an information field 1617 for a module A (product), a position field 1618 for the module A, and a dynamic/static state field 1619 for the module A.

The time field 1601 stores the information that determines the time instant at which the detection values detected by the worker sensor 1161, the apparatus sensor 1162, and the product sensor 1163 is detected. In this embodiment, information that determines the time instant at which the detection value detected by each of the sensors 1161 to 1163 is received by the sensed information processing apparatus 1100 is stored as the information that determines the time instant at which the detection value is detected. For example, “1”, “2”, “3”, . . . , and “n” correspond to the time instants of the detection of each sensor of “2 seconds after”, “4 seconds after”, “6 seconds after”, . . . , and “2n seconds after” the start of recording, respectively.

The worker position field 1602 stores information that determines the position of the worker to which the worker sensor 1161 is attached.

The worker acceleration (waist) field 1603 stores information that determines the action of the worker to which the worker sensor 1161 is attached.

The posture field 1604 stores information that determines the posture of the worker to which the worker sensor 1161 is attached.

The information field 1605 for the processing apparatus A stores information that determines the situation of the processing apparatus A. The situation of the processing apparatus A relates to the position and the operational status of the processing apparatus A which are described later.

The position field 1606 for the processing apparatus A stores information that determines the region including the position of the processing apparatus A.

The operation field 1607 for the processing apparatus A stores information that determines the operational status of the processing apparatus A (information indicating whether or not the processing apparatus A is in operation by ON or OFF).

The information field 1608 for the processing apparatus B stores information that determines the situation of the processing apparatus B. The situation of the processing apparatus B relates to the position and the operational status of the processing apparatus B which are described later.

The position field 1609 for the processing apparatus B stores information that determines the region including the position of the processing apparatus B.

The operation field 1610 for the processing apparatus B stores information that determines the operational status of the processing apparatus B (information indicating whether or not the processing apparatus B is in operation by ON or OFF).

The information field 1611 for the welding apparatus A stores information that determines the situation of the welding apparatus A. The situation of the welding apparatus A relates to the position and the operational status of the welding apparatus A which are described later.

The position field 1612 for the welding apparatus A stores information that determines the region including the position of the welding apparatus A.

The operation field 1613 for the welding apparatus A stores information that determines the operational status of the welding apparatus A (information indicating whether or not the welding apparatus A is in operation by ON or OFF).

The information field 1614 for the welding apparatus B stores information that determines the situation of the welding apparatus B. The situation of the welding apparatus B relates to the position and the operational status of the welding apparatus B which are described later.

The position field 1615 for the welding apparatus B stores information that determines the region including the position of the welding apparatus B.

The operation field 1616 for the welding apparatus B stores information that determines the operational status of the welding apparatus A (information indicating whether or not the welding apparatus B is in operation by ON or OFF).

The information field 1617 for the module A stores information that determines the state of the module A. Here, the information that determines the state of the module A is information that determines the position and a dynamic/static state (vibration state) of the module A which are described later.

The position field 1618 for the module A stores information that determines the region including the position of the module A.

The dynamic/static state field 1619 for the module A stores information that determines the dynamic/static state of the module A (information that determines whether the module A is moving or stopped).

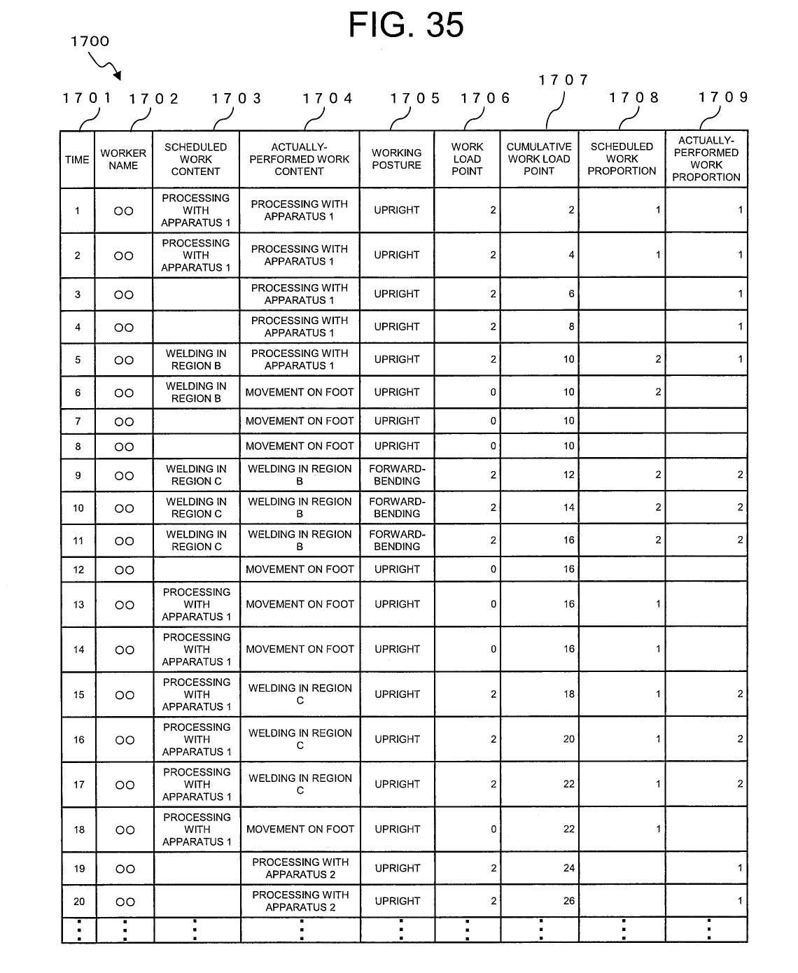

FIG. 35 illustrates a structure example of the output information table 1700.

The output information table 1700 includes a time field 1701, a worker name field 1702, a scheduled work content field 1703, an actually-performed work content field 1704, a working posture field 1705, a work load point field 1706, a cumulative work load point field 1707, a scheduled work proportion field 1708, and an actually-performed work proportion field 1709.

The time field 1701 stores information that determines the time instant.

The worker name field 1702 stores a name that identifies a person who performs the work.

The scheduled work content field 1703 stores information that determines a scheduled work content.

The actually-performed work content field 1704 stores information that determines a content of the work that has been actually performed.

The working posture field 1705 stores information that determines a working posture of the worker.

The work load point field 1706 stores the load point being a value indicating the load of the work.

The cumulative work load point field 1707 stores a cumulative work load point being a value obtained by accumulating the load points of the works on a worker-by-worker basis.

The scheduled work proportion field 1708 stores information for calculating a breakdown of the scheduled work content per work content from a proportion thereof.

The actually-performed work proportion field 1709 stores information for calculating a breakdown of the actually-performed work per work content from a proportion thereof.

Stored in the work determining information storage area 1127 is a work definition file 1650 for storing information that determines the work content from among the information sensed from the sensors 1161 to 1163.

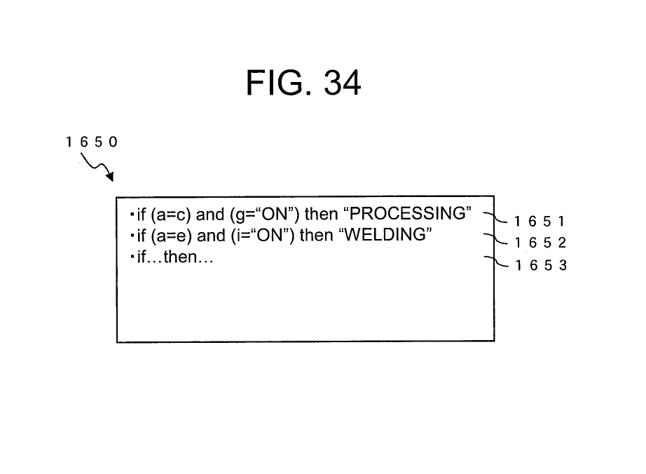

FIG. 34 illustrates a structure example of the work definition file 1650.

The work definition file 1650 is a file that associates the work content with the detection value that is received from the sensor and is to be a condition for determining the work content.

Specifically, the work definition file 1650 stores one or a plurality of description sentences 1651 to 1653 that are defined per work content. It should be noted that the description sentence 1651 is a sentence having a syntax that describes a condition following “if” and describes the work content to be determined following “then”.

For example, the description sentence 1651 “if (a=c) and (g=“ON”) then “processing”” indicates a definition that “the work content is “processing” if the value of the variable “a” and the value of the variable “c” are the same and if the value of the variable “g” is equal to “ON”. Here, the variables “a” and “c” included in the description sentence 1651 are variables that determine the fields, which store the respective detection values, of the worker sensed information table 1200, the apparatus sensed information table 1250, the product sensed information table 1300, and the environment sensed information table 1350 that are stored in the sensed information storage area 1121.

It should be noted that in this embodiment, it is desired that variables obtained from a plurality of tables are used in the condition of one description sentence. In particular, it is desired that variables obtained from the worker sensed information table 1200 and other tables are used.

FIG. 24 is referenced again for the description.

The control unit 1130 includes an input information reception module 1131, an output information generation module 1132, a sensed information management module 1133, and a sensed information processing module 1134.

The input information reception module 1131 receives information input through the input unit 1141 described later.

The output information generation module 1132 forms an output screen by combining information to be output and a screen layout, and makes the output unit 1142 described later to display the output screen.

The sensed information management module 1133 performs a processing which stores the detection value received from each of the sensors 1161 to 1164 via the communication unit 1143 described later in the sensed information storage area 1121.

Specifically, the sensed information management module 1133 stores a correlation between the sensor ID of the worker sensor 1161 and the worker ID for identifying the worker, and stores a worker ID corresponding to the sensor ID attached to a measured value received from the worker sensor 1161 in the ID field 1202 of the worker sensed information table 1200.

Further, the sensed information management module 1133 searches the values of the mounted sensor field 1503 of the sensor mounting table 1500 based on each of the sensor IDs of the sensors 1162 to 1164 to determine the value of the mounting target field 1501, and stores the received measured value in the corresponding table among the apparatus sensed information table 1250, the product sensed information table 1300, and the environment sensed information table 1350 for each of the determined mounting targets.

From the information stored in the sensed information storage area 1121, the sensed information processing module 1134 determines the work of the worker and calculates a work load or the like.

Specifically, the sensed information processing module 1134 determines the work content from the detection value that is detected by each of the sensors 1161 to 1163 and stored in the sensed information storage area 1121. In that case, the sensed information analysis module 1134 uses the work definition file 1650 within the work determining information storage area 1127 to determine the work content.

Then, the sensed information processing module 1134 calculates the work load by using the determined work content, the information on the worker stored in the worker information table 1400 within the worker information storage area 1122, and the information determining the work load which is stored in the work load information table 1450 stored in the work load information storage area 1123.

Further, the sensed information processing module 1134 calculates a value of an actually-performed work proportion from the determined work content.

Then, the sensed information processing module 1134 stores each of the determined work content, the work proportion, and the work load in the output information table 1700 within the output information storage area 1126.

The input unit 1141 receives an input of information from an operator.

The output unit 1142 outputs information.

The communication unit 1143 performs transmission/reception of information through the antenna 1150.

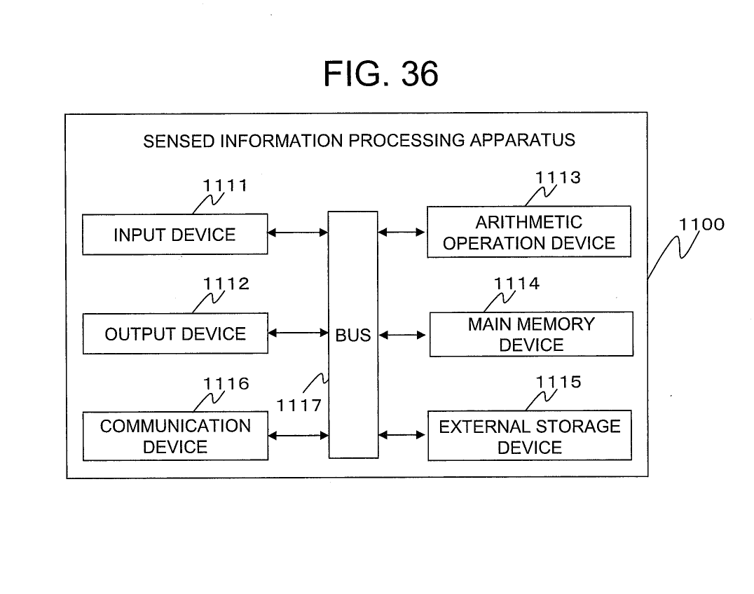

FIG. 36 is a diagram illustrating a hardware configuration of the sensed information processing apparatus 1100 according to this embodiment.

In this embodiment, the sensed information processing apparatus 1100 is a computer such as a client PC (personal computer), a workstation, a server device, each of various mobile phone terminals, or a personal digital assistant (PDA).

The sensed information processing apparatus 1100 includes an input device 1111, an output device 1112, an arithmetic operation device 1113, a main memory device 1114, an external storage device 1115, a communication device 1116, and a bus 1117 that connects the respective devices.

The input device 1111 is a device which receives an input such as a keyboard, a mouse, a touch pen, or other such pointing devices.

The output device 1112 is a device which performs displaying such as a display.

The arithmetic operation device 1113 is an arithmetic operation device such as a central processing unit (CPU).

The main memory device 1114 is a memory device such as a random access memory (RAM).

The external storage device 1115 is a nonvolatile storage device such as a hard disk drive or a flash memory.

The communication device 1116 is a communication device which performs radio communications through an antenna, such as a radio communication unit.

The input information reception module 1131, the output information generation module 1132, the sensed information management module 1133, and the sensed information processing module 1134 of the sensed information processing apparatus 1100 are implemented by programs that make the arithmetic operation device 1113 of the sensed information processing apparatus 1100 to perform processings.

The above-mentioned programs, which are stored within the main memory device 1114 or the external storage device 1115, are loaded onto the main memory device 1114 before execution thereof, and executed by the arithmetic operation device 1113.

Further, the storage unit 1120 of the sensed information processing apparatus 1100 is implemented by the main memory device 1114 or the external storage device 1115 of the sensed information processing apparatus 1100.

The input unit 1141 of the sensed information processing apparatus 1100 is implemented by the input device 1111 of the sensed information processing apparatus 1100.

The output unit 1142 of the sensed information processing apparatus 1100 is implemented by the output device 1112 of the sensed information processing apparatus 1100.

The communication unit 1143 of the sensed information processing apparatus 1100 is implemented by the communication device 1116 of the sensed information processing apparatus 1100.

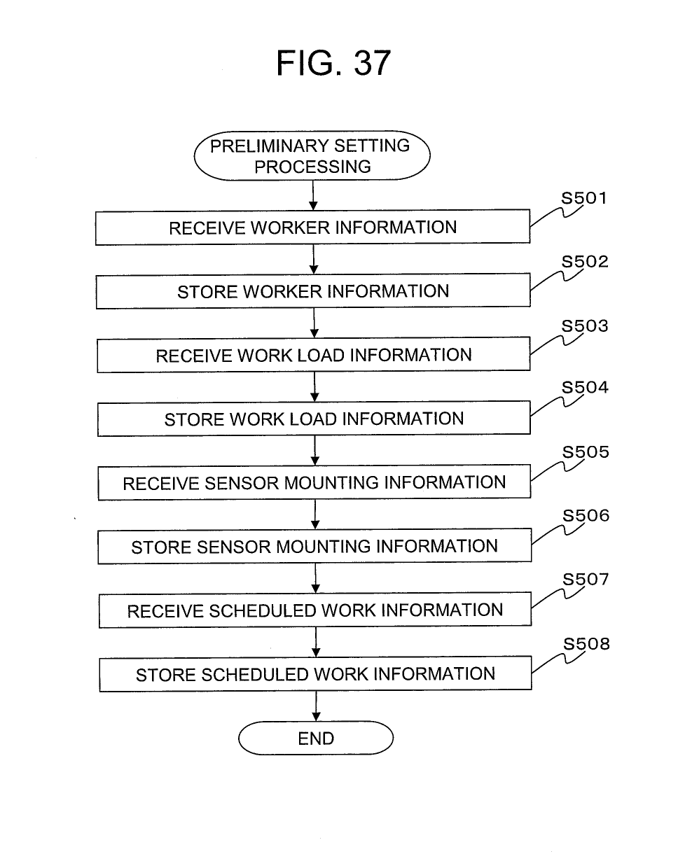

Next, FIG. 37 is referenced to describe a preliminary setting processing according to this embodiment.

FIG. 37 is a diagram illustrating a processing flow of the preliminary setting processing.

First, the input information reception module 1131 receives an input of worker information (Step S501).

For example, the input information reception module 1131 receives information on the worker including the full name, the professional career, the height, the sex, the age, the task-based team to which the worker belongs, and the sensor ID of the attached worker sensor 1161.

Then, the sensed information management module 1133 stores the worker information of which the input is received in Step S501 in the worker information table 1400 within the worker information storage area 1122 (Step S502).

Subsequently, the input information reception module 1131 receives an input of work load information (Step S503).

For example, the input information reception module 1131 receives the content of the work, the posture during the work, the sex, the age, conditions including the temperature of the work environment, and information on a work load point in a case where the conditions are satisfied.

Then, the sensed information management module 1133 stores information on the work load point of which the input is received in Step S503 in the work load information table 1450 within the work load information storage area 1123 (Step S504).

Subsequently, the input information reception module 1131 receives an input of sensor mounting information (Step S505).

For example, the input information reception module 1131 receives the mounting target of the sensor, the information that determines the region including the position of the mounting target, each of the IDs of the sensors 1162 to 1164 that are mounted, and information on the person in charge.

Then, the sensed information management module 1133 stores the sensor mounting information of which the input is received in Step S505 in the sensor mounting table 1500 within the sensor mounting information storage area 1124 (Step S506).

Subsequently, the input information reception module 1131 receives an input of scheduled work information (Step S507).

For example, the input information reception module 1131 receives the information that determines the time instant, the worker's name, and the scheduled work content.

Then, the sensed information management module 1133 stores the scheduled work information of which the input is received in Step S507 in the scheduled work information table 1550 within the scheduled work information storage area 1125 (Step S508).

The processing flow of the preliminary setting processing has been described above.

By performing such a preliminary setting processing, for example, before the start of the work, the information indicating the work situation can be processed appropriately.

It should be noted that the reception of the input information in Steps S501, S503, S505, and S507 may be omitted if no changes are made to the contents that have already been set.

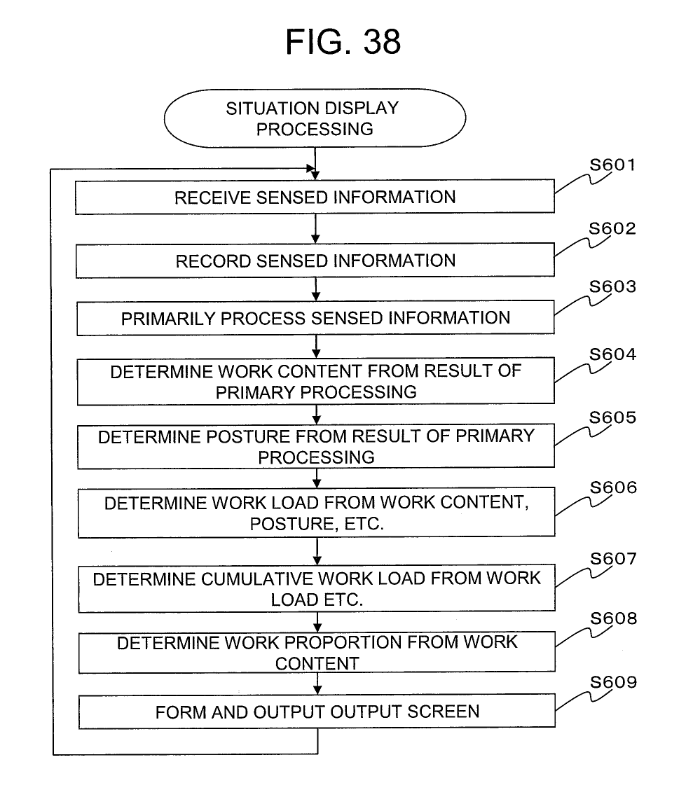

Next, FIG. 38 is referenced to describe the flow of the situation display processing according to this embodiment.

FIG. 38 is a flowchart illustrating the flow of the situation display processing.

First, the sensed information management module 1133 receives the detection value transmitted from each of the sensors 1161 to 1164 via the communication unit 1143 at predetermined intervals (for example, every two seconds) (Step S601).

Specifically, the sensed information management module 1133 receives the detection value transmitted from each of the sensors 1161 to 1164 via the communication unit 1143.

Subsequently, the sensed information management module 1133 stores the detection value received in Step S601 in each of the tables within the sensed information storage area 1121 (Step S602).

Specifically, the sensed information management module 1133 stores the acceleration and the position received from the worker sensor 1161 in the worker sensed information table 1200, stores the sensed information received from the apparatus sensor 1162 in the apparatus sensed information table 1250, stores the sensed information received from the product sensor 1163 in the product sensed information table 1300, and stores the temperature and the humidity received from the environment sensor 1164 in the environment sensed information table 1350.

Subsequently, the sensed information processing module 1134 primarily processes information stored in the sensed information storage area 1121 in Step S602 (Step S603).

Specifically, the sensed information processing module 1134 consolidates the information in the basic information table 1600 by using, as the keys, the information in the time field 1201 of each record of the worker sensed information table 1200, the time field 1251 of each record of the apparatus sensed information table 1250, the time field 1301 of each record of the product sensed information table 1300, and the time field 1351 of each record of the environment sensed information table 1350.

In a processing which performs consolidation, the sensed information processing module 1134 stores the value of the position field 1203 of the worker sensed information table 1200 in the worker position field 1602. Further, the sensed information processing module 1134 determines the value of the worker acceleration (waist) field 1603 from a relationship among the values of the X-axis acceleration field 1204, the Y-axis acceleration field 1205, and the Z-axis acceleration field 1206 of the worker sensed information table 1200.

For example, if the value of an X-axis acceleration and the value of a Z-axis acceleration fall within a specific range including zero (for example, minus 50 mG to 50 mG) and if the value of a Y-axis acceleration falls within a specific range including the gravitational acceleration (1,000 mG) (for example, 900 mG to 1,100 mG), the sensed information processing module 1134 determines that a change amount of the detection value from the previous time instant indicates any one of the states “static”, “minute movement”, and “vertical movement” according to a predefined range including the change amount, and stores the result in the worker acceleration (waist) field 1603. In this embodiment, the sensed information processing module 1134 judges that the change amount of the value of the Y-axis acceleration indicates a “static” state if being equal to or larger than 0 mG and equal to or smaller than 4 mG, a “minute movement” state if being larger than 4 mG and equal to or smaller than 30 mG, and a “vertical movement” state if being larger than 30 mG.

Further, in the processing which performs consolidation, the sensed information processing module 1134 determines the posture of the worker by using the values of the X-axis acceleration field 1204, the Y-axis acceleration field 1205, and the Z-axis acceleration field 1206 of the worker sensed information table 1200. It should be noted that in the processing which determines the posture of the worker, the sensed information processing module 1134 determines a predetermined range to which the value of the X-axis acceleration field 1204 of the worker sensed information table 1200 belongs, a predetermined range to which the value of the Y-axis acceleration field 1205 thereof belongs, and a predetermined range to which the value of the Z-axis acceleration field 1206 thereof belongs, determines an angle of the waist of the worker according to a combination of the determined ranges to which the values of the respective axes belong, and determines the value of the posture field 1604 based on the determined angle of the waist of the worker.

For example, if the value of the X-axis acceleration and the value of the Z-axis acceleration fall within the specific range including zero (for example, minus 50 mG to 50 mG) and if the value of the Y-axis acceleration falls within the specific range including the gravitational acceleration (for example, 900 mG to 1,100 mG), the sensed information processing module 1134 determines that an “upright” state is indicated, and stores a value to that effect in the posture field 1604. Further, if the resultant force of the X-axis acceleration, the Y-axis acceleration, and the Z-axis acceleration matches the gravitational acceleration, if the value of the X-axis acceleration falls within the specific range including zero (for example, minus 50 mG to 50 mG), and if the value of the Y-axis acceleration and the value of the Z-axis acceleration respectively fall within a predetermined range including a value obtained by dividing 1,000 by the square root of 2 (for example, range between plus and minus 50 mG of the value obtained by dividing 1,000 by the square root of 2), the sensed information processing module 1134 determines that a “forward-bending (state in which the worker tilts his/her upper body forward by 45°)” state is indicated, and stores a value to that effect in the posture field 1604.

Further, if the resultant force of the X-axis acceleration, the Y-axis acceleration, and the Z-axis acceleration matches the gravitational acceleration, if the value of the X-axis acceleration falls within the predetermined range including zero (for example, minus 50 mG to 50 mG), if the value of the Y-axis acceleration falls within a predetermined range including a value obtained by multiplying 500 mG by the square root of 3 (for example, range between plus and minus 50 mG of the value obtained by multiplying 500 mG by the square root of 3), and if the value of the Z-axis acceleration falls within a predetermined range including 500 mG (for example, range from 450 mG to 550 mG), the sensed information processing module 1134 determines that a “forward-leaning (state of being tilted forward at an angle smaller than the forward-bending)” state is indicated, and stores a value to that effect in the posture field 1604.

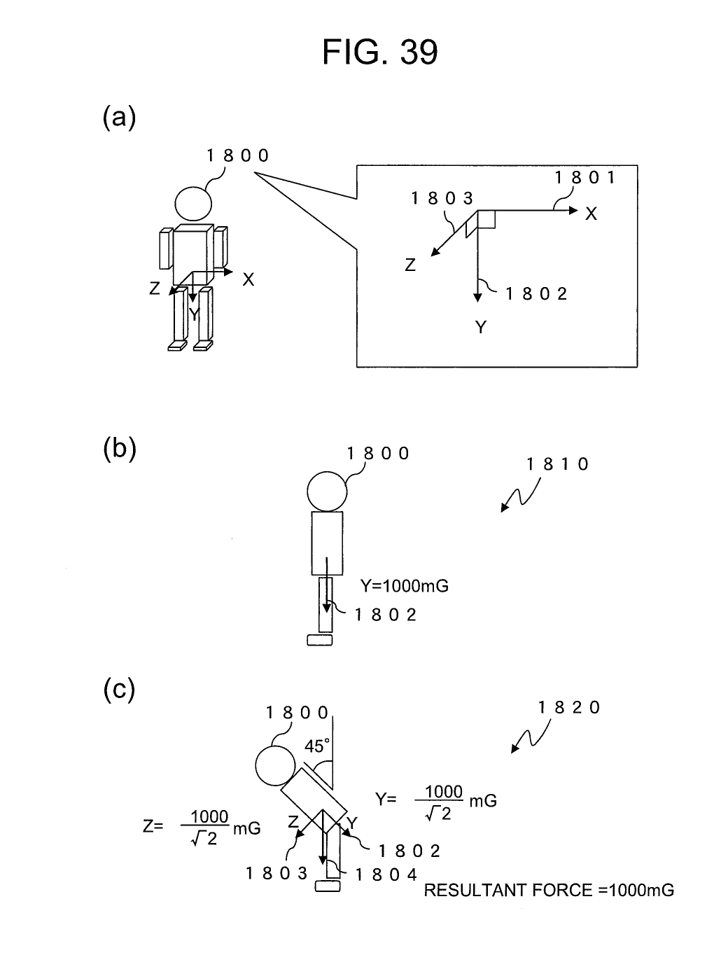

FIG. 39 are referenced to supplementarily describe a mechanism for determining the posture.

FIG. 39 are diagrams illustrating the values of the acceleration acquired by the worker sensor 1161 attached to the waist among the worker sensors 1161 attached to the worker.

First, FIG. 39(a) is a diagram illustrating a relationship among an X-axis 1801, a Y-axis 1802, and a Z-axis 1803 of the worker sensor 1161 attached to a worker 1800.

With regard to the X-axis 1801, the Y-axis 1802, and the Z-axis 1803, in a case where the worker 1800 is static in an upright posture, the X-axis 1801 is a horizontal direction extending from the center of his/her body (waist) toward a side of the body, the Y-axis 1802 is a vertical direction extending from the center of the body (waist) toward his/her feet, and the Z-axis 1803 is a horizontal direction extending from the center of the body (waist) toward the front side of the body. The X-axis 1801, the Y-axis 1802, and the Z-axis 1803 are perpendicular to one another.

Further, as illustrated in FIG. 39(b), in an upright state 1810 of the worker, the acceleration toward the Y-axis 1802 direction is detected as 1,000 mG (milli-G) being the gravitational acceleration by the worker sensor 1161.

In other words, if the acceleration of the X-axis 1801 and the acceleration of the Z-axis 1803 fall within the predetermined value range including zero (for example, range from minus 50 mG to 50 mG) and if the acceleration of the Y-axis 1802 falls within the predetermined value range including the gravitational acceleration (for example, range from 900 mG to 1,100 mG), it is highly probable that the worker 1800 is upright.

Further, as illustrated in FIG. 39(c), in a state 1820 in which the worker 1800 leans his/her upper body forward at an angle of 45°, the accelerations having substantially the same amount (both having the value obtained by dividing 1,000 mG by the square root of 2) are detected in the Z-axis 1803 and the Y-axis 1802. In other words, if the acceleration of the Z-axis 1803 and the acceleration of the Y-axis 1802 have substantially the same amount, it is highly probable that the worker 1800 is in the forward-leaning state.

Naturally, in the above-mentioned manner, the angle at which the worker is leaning forward may be determined from the ranges to which the value of the X-axis acceleration, the value of the Y-axis acceleration, and the value of the Z-axis acceleration belong, and a predefined posture corresponding to the angle of the forward-leaning may be determined, but the present invention is not limited thereto. The angle at which the worker is leaning forward may be determined from a proportional relationship among the value of the X-axis acceleration, the value of the Y-axis acceleration, and the value of the Z-axis acceleration, to thereby determine the posture of the worker.

It should be noted that the values of the acceleration collected by the worker sensor 1161 are assumed to include a component that determines the posture and a kinetic component as a noise component, and hence the sensed information processing module 1134 can improve accuracy for determining the posture by setting the worker sensor 1161 to equalize the values of the acceleration recorded a predetermined number of times (for example, 40 times) for a predetermined period (for example, for 2 seconds) and transmitting the equalized value to the sensed information processing apparatus 1100. This is because the equalization reduces the noise component.

FIG. 38 is referenced again to describe the processing flow.

In a consolidation processing of Step S603, if the value of the processing apparatus A's voltage field 1252 of the apparatus sensed information table 1250 exceeds a predetermined value (for example, 50 volts), the sensed information processing module 1134 stores information that the processing apparatus A is in operation in the operation field 1607 for the processing apparatus A. Further, the information on the position indicated by the value of the placement position field 1502 of the sensor mounting table 1500 is stored in the position field 1606 for the processing apparatus A.

Similarly, in the consolidation processing of Step S603, if the value of the processing apparatus B's voltage field 1253 of the apparatus sensed information table 1250 exceeds the predetermined value, the sensed information processing module 1134 stores information that the processing apparatus B is in operation in the operation field 1610 for the processing apparatus B. Further, the information on the position indicated by the value of the placement position field 1502 of the sensor mounting table 1500 is stored in the position field 1609 for the processing apparatus B.

Further, in the consolidation processing of Step S603, if the value of the welding apparatus A's gas flow rate field 1254 of the apparatus sensed information table 1250 exceeds a predetermined value (for example, 2 milliliters), the sensed information processing module 1134 stores information that the welding apparatus A is in operation in the operation field 1613 for the welding apparatus A. Further, the information on the position indicated by the value of the placement position field 1502 of the sensor mounting table 1500 is stored in the position field 1612 for the welding apparatus A.

Similarly, in the consolidation processing of Step S603, if the value of the welding apparatus B's gas flow rate field 1255 of the apparatus sensed information table 1250 exceeds the predetermined value, the sensed information processing module 1134 stores information that the welding apparatus B is in operation in the operation field 1616 for the welding apparatus B. Further, the information on the position indicated by the value of the placement position field 1502 of the sensor mounting table 1500 is stored in the position field 1615 for the welding apparatus B.

Then, in the consolidation processing of Step S603, the sensed information processing module 1134 stores the information that determines the region including the position indicated by the value of the position field 1303 of the product sensed information table 1300, in the position field 1618 for the module A. Then, if there exists a change in the detection value from the adjacent previous time instant with regard to any one of the value of the X-axis acceleration field 1304, the value of the Y-axis acceleration field 1305, and the value of the Z-axis acceleration field 1306, the sensed information processing module 1134 stores information that there is a movement in the module (product), in the dynamic/static state field 1619 for the module A according to the amount of the change. For example, if an absolute value of the change amount of the X-axis acceleration is equal to or larger than 0 mG and equal to or smaller than 8 mG, the sensed information processing module 1134 assumes the movement of the module A to be “static”, in other words, in the static state and stores a value to that effect in the dynamic/static state field 1619 for the module A. If the absolute value of the change amount exceeds 8 mG, the sensed information processing module 1134 assumes the movement to be “dynamic”, in other words, not in the static state and stores a value to that effect in the dynamic/static state field 1619 for the module A.

In such a manner, the sensed information processing module 1134 primarily processes the sensed information.

Subsequently, the sensed information processing module 1134 determines the work content of the worker from the primarily-processed information at each of the sensed time instants (Step S604).

Specifically, the sensed information processing module 1134 judges the record stored in the basic information table 1600 according to the conditions included in the work definition file 1650, determines the work content of the record satisfying the conditions, and stores the information that determines the work content in the actually-performed work content field 1704 of the output information table 1700.

For example, if the value of the worker position field 1602 is “A”, if the value of the worker acceleration (waist) field 1603 is “minute”, and if the value of the operation field 1607 for the processing apparatus A is “ON”, in a case where the work content defined by the work definition file 1650 is “processing” under the same conditions, the sensed information processing module 1134 stores the fact of being in “processing” in the actually-performed work content field 1704 of the output information table 1700.

Further, for example, if the value of the worker acceleration (waist) field 1603 has changed from the position at the previous time instant, the sensed information processing module 1134 judges that the worker has moved on foot within the workplace, and stores the fact of being in the “movement on foot” in the actually-performed work content field 1704 of the output information table 1700.

Subsequently, the sensed information processing module 1134 determines the posture of the worker from the primarily-processed information at each of the sensed time instants (Step S605).

Specifically, the sensed information processing module 1134 acquires the information of the posture field 1604 from the record stored in the basic information table 1600, and stores the information in the working posture field 1705 of the output information table 1700.

Subsequently, the sensed information processing module 1134 determines the work load on the worker from the work content determined in Step S604, the posture of the worker determined in Step S605, and the like (Step S606).

Specifically, the sensed information processing module 1134 searches the work load information table 1450 to determine the record satisfying the conditions from the value of the actually-performed work content field 1704 which indicates the work content determined in Step S604, the value of the working posture field 1705 which indicates the posture of the worker determined in Step S605, the value of the sex field 1405 which indicates the sex of the worker, the value of the age field 1406 which indicates the age of the worker, the value of the region field 1352 which indicates the region to which the position in which the worker exists belongs, and the value of the temperature field 1353 which indicates the temperature of the region.

In the search processing, the sensed information processing module 1134 narrows the records of the work load information table 1450 down to the records in which the values of the work content field 1452 and the working posture field 1453 match the values of the actually-performed work content field 1704 and the working posture field 1705, respectively, of the output information table 1700 and in which the value of the sex field 1454 matches the value of the worker's sex field 1405 of the worker information table 1400.

Then, the sensed information processing module 1134 further narrows the narrowed-down records down to the records in which the value of the tens place of the value of the age field 1454 matches the value of the tens place of the value of the age field 1406 of the worker information table 1400.

Then, from among the narrowed-down records, the sensed information processing module 1134 determines the record in which the value of the tens place of the value of the temperature field 1456 matches the value of the tens place of the value of the temperature field 1353 of the environment sensed information table 1350 regarding the position of the position field 1203 of the worker.

Then, the sensed information processing module 1134 acquires the value of the load point field 1457 of the determined record, and stores the value in the work load point field 1706 of the output information table 1700.

Subsequently, the sensed information processing module 1134 stores a new cumulative work load point in the cumulative work load point field 1707 by adding the work load point determined in Step S606 to the work load point obtained by accumulating the work load points at the respective previous time instants (Step S607).

Subsequently, the sensed information processing module 1134 determines the work proportion from the work content determined in Step S604 (Step S608).

Specifically, the sensed information processing module 1134 stores the value corresponding to the content of the work in the actually-performed work proportion field 1709 with regard to the value of the actually-performed work content field 1704 of the output information table 1700 in which the work content determined in Step S604 is stored. For example, the sensed information processing module 1134 stores a value of “1” for “processing” and a value of “2” for “welding” in the actually-performed work content field 1709.

Further, the sensed information processing module 1134 simultaneously stores the values of the worker name field 1552 and the scheduled work content field 1553 of the scheduled work information table 1550 in the corresponding worker name field 1702 and the corresponding scheduled work content field 1703, respectively, of the output information table 1700.

Then, the sensed information processing module 1134 stores the value corresponding to the content of the work in the scheduled work proportion field 1708 also with regard to the value of the scheduled work content field 1703.

Then, the sensed information processing module 1134 calculates a proportion of time in a period covering all the time instants indicated by the time field 1701 for each value stored in the scheduled work proportion field 1708, in other words, each scheduled work content, and stores the proportion as a (scheduled) work proportion in a region (not shown) of the output information storage area 1126.

In the same manner, the sensed information processing module 1134 calculates a proportion of time in the period covering all the time instants indicated by the time field 1701 for each value stored in the actually-performed work proportion field 1709, in other words, each actually-performed work content, and stores the proportion as an (actually-performed) work proportion in a region (not shown) of the output information storage area 1126.

Subsequently, the output information generation module 1132 forms and outputs an output screen 1900 (Step S609).

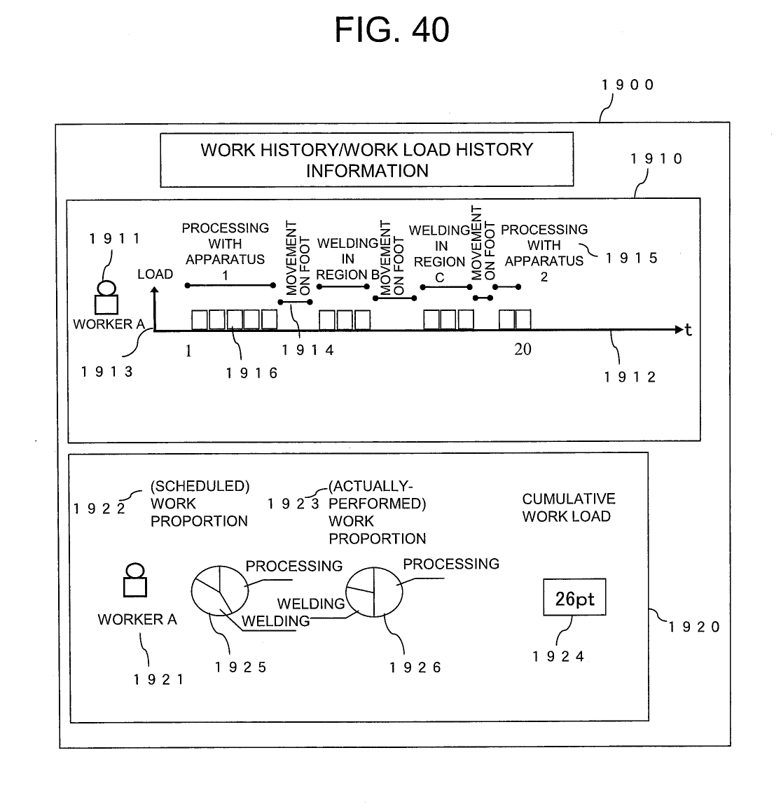

FIG. 40 is a diagram illustrating a structure example of the output screen 1900 output in Step S609. The output screen 1900 includes a work history display area 1910 and a work load display area 1920.

The work history display area 1910 includes a worker indicating icon 1911, a time axis 1912 serving as a horizontal axis, a load axis 1913 serving as a vertical axis, a work indicating line 1914, a work content display area 1915, and a work load display area 1916. The work indicating line 1914 is a line indicating the work content of the worker indicated by the worker indicating icon 1911 as a work line along the time axis 1912. Further, the work load display area 1916 arranges and displays rectangular graphics, each of which is shown to be taller as the work load point is heavier, along the time axis 1912. In other words, the taller the height of the rectangular graphic is, the heavier the work load on the worker is.

The work load display area 1920 includes a worker indicating icon 1921, a scheduled work proportion display field 1922 which indicates the scheduled work proportion, an actually-performed work proportion display field 1923 which indicates the actually-performed work proportion, an cumulative work load point display field 1924 which indicates the cumulative work load point, a scheduled work proportion graph display field 1925 which displays the scheduled work proportion in a pie chart, and an actually-performed work proportion graph display field 1926 which displays the actually-performed work proportion in a pie chart.

The output information generation module 1132 makes the value of the worker name field 1702 of the output information table 1700 to be displayed with the worker indicating icons 1911 and 1921. Then, the output information generation module 1132 makes the work indicating line 1914 and the work content display area 1915 to be displayed based on the values of the actually-performed work content field 1704, and makes the graphics to be displayed in the work load display area 1916 based on the values of the work load point field 1706.

Further, in the scheduled work proportion graph display field 1925, the output information generation module 1132 forms and displays a pie chart based on the information stored as the (scheduled) work proportion in the region (not shown) of the output information storage area 1126 in Step S608. In the same manner, in the actually-performed work proportion graph display field 1926, the output information generation module 1132 forms and displays a pie chart based on the information stored as the (actually-performed) work proportion in the region (not shown) of the output information storage area 1126 in Step S608. Further, the output information generation module 1132 makes the value of the cumulative work load point field 1707 to be displayed in the cumulative work load point display field 1924. Then, the sensed information processing module 1134 returns the control to Step S601 to restart the processing.

The processing flow of the situation display processing has been described above.

By performing the situation display processing, it is possible to output and display detailed information on the work load that is hard to quantify on the display or the like in real time, and to allow a work supervisor or the like to quantitatively understand the load on the worker at a glance.

The specific description is made above based on the fifth embodiment, but the present invention is not limited thereto, and various changes can be made without departing from the gist thereof.

For example, the number of workers to be displayed in Step S609 of the above-mentioned situation display processing is not limited to one, and a plurality of workers may be displayed.

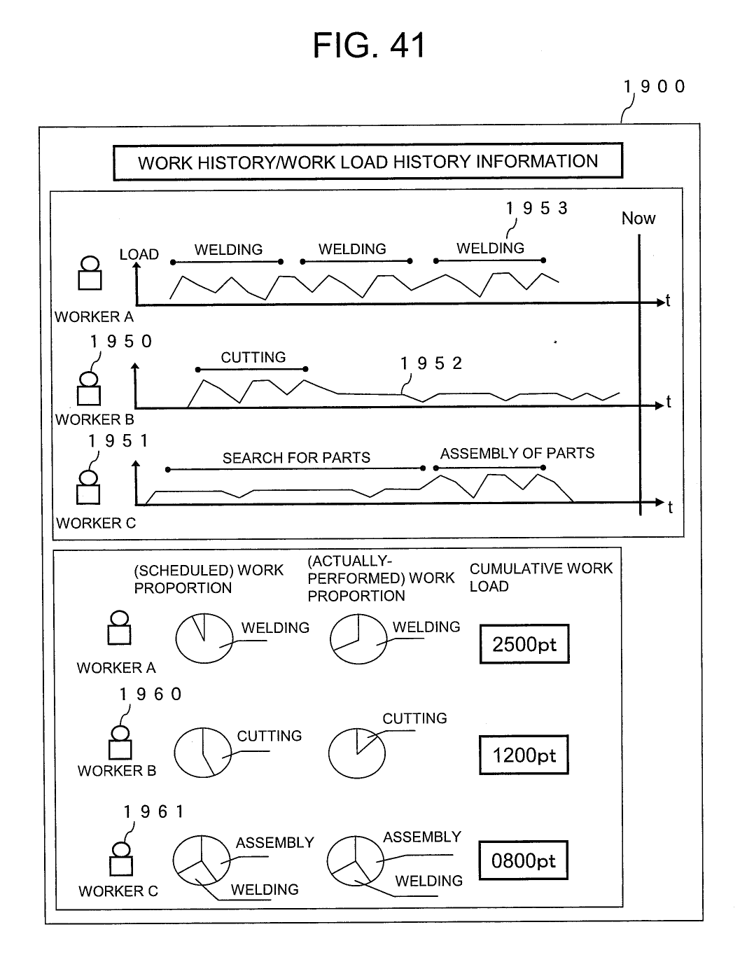

Specifically, as illustrated in FIG. 41, the output information generation module 1132 may display information on a plurality of workers 1950, 1951, 1960, and 1961 in the work history display area and the work load display area.

With this configuration, the information can be compared among a plurality of workers. In other words, this configuration is useful for improvement of work efficiency by, for example, leveling the work loads or determining the worker exhibiting high work efficiency to extract a point of his/her superiority in comparison with the worker exhibiting low working efficiency.

Further, as illustrated in a work content display area 1953 of FIG. 41, the output information generation module 1132 may display a characteristic work content. In other words, the work content whose work time lasted for a predetermined period or longer may be displayed in the work content display area 1953.

With this configuration, characteristic information can be displayed accurately when the work contents of the plurality of workers are indicated.

Further, as illustrated in a work load display area 1952 of FIG. 41, the output information generation module 1132 may display the work loads by using a graph such as a line graph.

With this configuration, the characteristic information can be displayed accurately even when the work contents of the plurality of workers are indicated.

Further, when determining the work load in Step S606, the sensed information processing module 1134 may correct the work load point according to the work content of the worker performed so far.

For example, even the work load on the same work may differ between the morning in which the work is started and the evening immediately before the work is finished, and hence the load point may be corrected by the time instant according to the work content (for example, the work load on the work at a time instant later than a predetermined time instant may be set 1.5 times heavier). Further, for example, in the same manner, the work load may differ between the states in which a cumulative work load is high and low when the same work is performed, and hence the load point may be corrected according to the cumulative work load (for example, the work load may be set 1.5 times heavier when the cumulative work load is higher than a predetermined value). Naturally, a combination thereof may be used to correct the load point.

Further, the sensed information processing apparatus 1100 is configured to operate on a standalone basis, but the present invention is not limited thereto, and may serve as, for example, the server device which provides a service via a communication protocol such as a hyper text transfer protocol (HTTP) to receive an input instruction from another terminal device via a network and makes the terminal device to display an output.

With such changes, the user becomes capable of operating the sensed information processing apparatus 1100 through another terminal connected to the network, and it is possible to enhance the degree of freedom of the equipment configuration and the convenience of the user.

Further, in the above-mentioned embodiment, the sensed information processing apparatus 1100 receives the information on the position and the acceleration transmitted from the worker sensor 1161, but the present invention is not limited thereto as long as the sensed information processing apparatus 1100 can receive such information as to determine the position, the work content, or the posture.

For example, the sensing device mounted in each workplace may sense the radio wave transmitted by the radio wave transmitting device attached to the target worker, and transmit the identification information on the worker and the information that identifies the sensing device to the sensed information processing apparatus 1100 so that the sensed information processing apparatus 1100 may determine the position and the posture of the worker captured by the sensing device by the information that identifies the sensing device.

With this configuration, the worker sensor 1161 can be easily downsized.

Further, the works to be sensed are not limited to the works within the factory, but can include various works and actions such as works in a kitchen of a restaurant or actions of a player in a sports game.

It should be noted that the sensed information processing apparatus 1100 is not only to be dealt as an apparatus, but can also be dealt in units of program components that implement operations of the apparatus.

### REFERENCE SIGNS LIST

100: sensed information processing apparatus, 111: input device, 112: output device, 113: arithmetic operation device, 114: main memory device, 115: external storage device, 116: communication device, 117: bus, 120: storage unit, 121: sensed information storage area, 122: corresponding time instant information storage area, 130: control unit, 131: input information reception module, 132: output information generation module, 133: sensed information management module, 134: sensed information analysis module, 141: input unit, 142: output unit, 143: communication unit, 150: antenna, 161: sensor, 200: sensed information table, 300: process-step definition table, 450: region table, 500: output information table, 600: output information table, 700: sensed information table, 750: output information table, 800: sensed information processing apparatus, 820: storage unit, 825: work identification regional information storage area, 830: work item input reception module, 832: output information generation module, 833: sensed information management module, 834: sensed information analysis module, 860: detailed region table, 900: output information table, 1000: work information processing system, 1100: sensed information processing apparatus, 1111: input device, 1112: output device, 1113: arithmetic operation device, 1114: main memory device, 1115: external storage device, 1116: communication device, 1117: bus, 1120: storage unit, 1121: sensed information storage area, 1122: corresponding time instant information storage area, 1130: control unit, 1131: input information reception module, 1132: output information generation module, 1133: sensed information management module, 1134: sensed information processing module, 1141: input unit, 1142: output unit, 1143: communication unit, 1150: antenna, 1161: sensor, 1162: apparatus sensor, 1163: product sensor, 1164: environment sensor, 2000: work information processing system

1. A work information processing apparatus, comprising:
a storage unit which stores process-step definition information comprising a position and a process step associated with the position; and
a control unit,
wherein the control unit is configured to:
receive a detection value that indicates a position detected by a sensor attached to a sensing target and information that determines a time instant at which the detection value is detected, as detected information;
determine the process step associated with the position indicated by the detection value from the process-step definition information; and
display a change of the process step in which the sensing target exists, according to detected time instants in coordinates having at least the process step as an axis thereof.

2. A work information processing apparatus according to claim 1, wherein:
the position stored in the process-step definition information comprises a predetermined area;
the predetermined area is associated with the process step on a one-to-one basis; and
the control unit determines the process step by determining the area including the position indicated by the detection value, in the processing which determines the process step.

3. A work information processing apparatus according to claim 1, wherein the control unit displays, on a screen having an axis indicating the process step and an axis indicating the time instant that are perpendicular to each other, a point at which a predetermined position in the determined process step and the time instant intersect for each of the sensing targets, in the display processing.

4. A work information processing apparatus according to claim 1, wherein:
the process-step definition information further comprises a required time for the process step; and
the control unit displays a ratio of an elapsed time to the required time for each of process steps for each of the sensing targets, in the display processing.

5. A work information processing apparatus according to claim 4, wherein the control unit sets a time taken until the determined process step changes as the elapsed time for each of the sensing target items, in the processing which displays the ratio of the elapsed time.

6. A work information processing apparatus according to claim 1, wherein the control unit is configured to:
receive detection values that indicate an acceleration and the position detected by the sensor attached to a sensing target person as the detected information and information that determines a time instant at which the detection values are detected, as detected information;
determine the process step associated with the position indicated by the detection values; and
display a change of the detection values indicating the acceleration at the time instant when the detection value is detected, in the position indicating the process step.

7. A work information processing apparatus according to claim 6, wherein the control unit further displays alert information if a fluctuation width of the detection values indicating the acceleration is equal to or smaller than a predetermined value, in the processing which displays the detection values indicating the acceleration.

8. A work information processing apparatus according to claim 1, wherein:
the storage unit stores detailed regional information comprising a position and a detailed work within the process step which is associated with the position; and
the control unit is further configured to:
determine, when receiving an instruction to display the detailed work within the process step, the detailed work within the process step associated with the position indicated by the detection value from the detailed regional information; and
display a change of the detailed work within the process step in which the sensing target exists, according to the detected time instants in coordinates having at least the detailed work as an axis thereof.

9. A program, which controls a computer to function as:
storage means which stores process-step definition information comprising a position and a process step associated with the position; and
control means,
the program further controlling the control means to execute:
a processing which receives a detection value that indicates a position detected by a sensor attached to a sensing target and information that determines a time instant at which the detection value is detected, as detected information;
a processing which determines the process step associated with the position indicated by the detection value from the process-step definition information; and
a processing which displays a change of the process step in which the sensing target exists, according to detected time instants in coordinates having at least the process step as an axis thereof.

10. A program according to claim 9, wherein:
the position stored in the process-step definition information comprises a predetermined area;
the predetermined area is associated with the process step on a one-to-one basis; and
the program further controls the control means to execute a processing which determines the process step by determining the area including the position indicated by the detection value, in the processing which determines the process step.

11. A program according to claim 9, wherein the program further controls the control means to execute a processing which displays, on a screen having an axis indicating the process step and an axis indicating the time instant that are perpendicular to each other, a point at which a predetermined position in the determined process step and the time instant intersect for each of the sensing targets, in the display processing.

12. A program according to claim 9, wherein:
the process-step definition information further comprises a required time for the process step; and
the program further controls the control means to execute a processing which displays a ratio of an elapsed time to the required time for each of process steps for each of the sensing targets, in the display processing.

13. A program according to claim 12, wherein the program further controls the control means to set a time taken until the determined process step changes as the elapsed time for each of the sensing target items, in the processing which displays the ratio of the elapsed time.

14. A program according to claim 9, wherein the program further controls the control means to execute:
a processing which receives detection values that indicate an acceleration and the position detected by the sensor attached to a sensing target person as the detected information and information that determines a time instant at which the detection values are detected, as detected information;
a processing which determines the process step associated with the position indicated by the detection values; and
a processing which displays a change of the detection values indicating the acceleration at the time instant when the detection value is detected, in the position indicating the process step.

15. A program according to claim 14, wherein the program further controls the control means to display alert information if a fluctuation width of the detection values indicating the acceleration is equal to or smaller than a predetermined value, in the processing which displays the detection values indicating the acceleration.

16. A program according to claim 9, wherein:
the storage unit stores detailed regional information comprising a position and a detailed work within the process step which is associated with the position; and
the program further controls the control means to execute:
a processing which receives an instruction to display the detailed work within the process step;
a processing which determines the detailed work within the process step associated with the position indicated by the detection value from the detailed regional information; and
a processing which displays a change of the detailed work within the process step in which the sensing target exists, according to the detected time instants in coordinates having at least the detailed work as an axis thereof.

17. A work information processing method, which is performed by a work information processing apparatus, wherein:
the work information processing apparatus comprising:
a storage unit which stores process-step definition information comprising a position and a process step associated with the position; and
a control unit, wherein:
the control unit performs:
a procedure which receives a detection value that indicates a position detected by a sensor attached to a sensing target and information that determines a time instant at which the detection value is detected, as detected information;
a procedure which determines the process step associated with the position indicated by the detection value from the process-step definition information; and
a processing which displays a change of the process step in which the sensing target exists, according to detected time instants in coordinates having at least the process step as an axis thereof.

18. A work information processing apparatus, comprising:
a storage unit which stores work content definition information obtained by associating information determining a detection value sensed by a sensor with a work content; and
a control unit,
wherein the control unit is configured to:
receive a detection value detected by a sensor attached to a first sensing target, information that determines a time instant at which the detection value of the first sensing target is detected, a detection value detected by a sensor attached to a second sensing target, and information that determines a time instant at which the detection value of the second sensing target is detected;
determine the work content based on the detection value detected by the sensor attached to the first sensing target and the detection value detected by the sensor attached to the second sensing target according to the work content definition information; and
display the determined work content according to information that determines the detected time instant.

19. A work information processing apparatus according to claim 18, wherein:
the information sensed by the sensor within the work content definition information comprises a position, an acceleration, and an operational status of a tool;
the sensor attached to the first sensing target detects a detection value that indicates the detected position, a detection value that indicates the acceleration, and information that determines a time instant at which the detection values are detected;
the second sensing target comprises the tool used for a work, a sensor attached to the tool detecting a detection value that indicates a use situation of the tool and information that determines a time instant at which the detection value is detected; and
the control unit determines the work content associated by the work content definition information from the detection value that indicates the position, the detection value that indicates the acceleration, and the detection value that indicates the use situation of the tool.

20. A work information processing apparatus according to claim 19, wherein:
the storage unit further stores information that determines a work load defined according to at least the work content and a working posture; and
the control unit is further configured to:
determine the working posture from the detection value that indicates the acceleration;
determine the work load according to the determined work content and the working posture; and
display the determined work load according to the information that determines the detected time instant.

21. A work information processing apparatus according to claim 20, wherein the control unit determines, when determining the working posture, that a predefined working posture is being exhibited if the detection value that indicates the acceleration is close to a predefined value.

22. A work information processing apparatus according to claim 20, wherein the control unit further calculates a cumulative work load by accumulating the determined work load and displays the cumulative work load.

23. A work information processing apparatus according to claim 18, wherein the control unit calculates a time taken for the work for each determined work content, calculates a ratio thereof to a time elapsed for the sensing, and displays the ratio.

24. A program, which controls a computer to function as:
storage means which stores work content definition information obtained by associating information determining a detection value sensed by a sensor with a work content; and
control means,
the program further controlling the control means to execute:
a processing which receives a detection value detected by a sensor attached to a first sensing target, information that determines a time instant at which the detection value of the first sensing target is detected, a detection value detected by a sensor attached to a second sensing target, and information that determines a time instant at which the detection value of the second sensing target is detected;
a processing which determines the work content based on the detection value detected by the sensor attached to the first sensing target and the detection value detected by the sensor attached to the second sensing target according to the work content definition information; and
a processing which displays the determined work content according to information that determines the detected time instant.

25. A program according to claim 24, wherein:
the information sensed by the sensor within the work content definition information comprises a position, an acceleration, and an operational status of a tool;
the information received from the sensor attached to the first sensing target comprises a detection value that indicates the detected position, a detection value that indicates the acceleration, and information that determines a time instant at which the detection values are detected;
the second sensing target comprises the tool used for a work, and information received from a sensor attached to the tool comprises a detection value that indicates a use situation of the tool and information that determines a time instant at which the detection value is detected; and
the program further controls the control unit to determine the work content associated by the work content definition information from the detection value that indicates the position, the detection value that indicates the acceleration, and the detection value that indicates the use situation of the tool.

26. A program according to claim 25, wherein:
the storage unit further stores information that determines a work load defined according to at least the work content and a working posture; and
the program further controls the control unit to execute:
a processing which determines the working posture from the detection value that indicates the acceleration;
a processing which determines the work load according to the determined work content and the working posture; and
a processing which displays the determined work load according to the information that determines the detected time instant.

27. A program according to claim 26, wherein the program further controls the control unit to execute a processing which determines, when determining the working posture, that a predefined working posture is being exhibited if the detection value that indicates the acceleration is close to a predefined value.

28. A program according to claim 26, wherein the program further controls the control unit to execute a processing which calculates a cumulative work load by accumulating the determined work load and display the cumulative work load.

29. A program according to claim 24, wherein the program further controls the control unit to execute a processing which calculates a time taken for the work for each determined work content, calculates a ratio thereof to a time elapsed for the sensing, and displays the ratio.

30. A work information processing method, which is performed by a work information processing apparatus, wherein:
the work information processing apparatus comprising:
a storage unit which stores work content definition information obtained by associating information determining a detection value sensed by a sensor with a work content; and
a control unit, wherein:
the control unit performs:
a processing which receives a detection value detected by a sensor attached to a first sensing target, information that determines a time instant at which the detection value of the first sensing target is detected, a detection value detected by a sensor attached to a second sensing target, and information that determines a time instant at which the detection value of the second sensing target is detected;
a processing which determines the work content based on the detection value detected by the sensor attached to the first sensing target and the detection value detected by the sensor attached to the second sensing target according to the work content definition information; and
a processing which displays the determined work content along information that determines the detected time instant.
